(19) United States
(12) Patent Application Publication
(10) Pub. No.: US 2026/0289269 A1
(43) Pub. Date: Sep. 24, 2026

(54) SYSTEM

(71) Applicant: SoftBank Group Corp., Tokyo (JP)

(72) Inventor: Tomoya GO, Tokyo (JP)

(73) Assignee: SoftBank Group Corp., Tokyo (JP)

(21) Appl. No.: 19/566,340

(22) Filed: Mar. 13, 2026

(30) Foreign Application Priority Data
Mar. 19, 2025 (JP) 2025-044916

(51) Int. Cl. G06N 3/0475; G06N 3/044; G06Q 30/0202

(52) U.S. Cl. CPC G06N 3/0475; G06N 3/044; G06Q 30/02024

(57) ABSTRACT

A system acquires user identification data from a terminal device and associates the user identification data with account identification data of one or more external service platforms. Target item registration data including attribute data and periodicity data for monitored items is stored. Historical transaction records are collected from the external service platforms, preprocessed, and used as learning data to train a time-series machine learning model that outputs prediction data indicating a predicted time interval until a next occurrence for each monitored item. Current condition data from external information sources is analyzed to determine recommendation data including recommended timing and condition parameters. A prompt data structure including the prediction data and recommendation data is provided to a generative neural network model to generate notification text transmitted to the terminal device.; and transmit the sentence to the user through the communication application.

### CROSS-REFERENCE TO RELATED APPLICATION

This application is based on and claims priority under 35 USC 119 from Japanese Patent Application No. 2025-044916 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional electronic commerce systems and communication applications are not sufficiently integrated to support efficient and timely purchasing of articles that users buy on a periodic basis. In typical systems, a user is required to manually monitor inventory of articles, remember expected replenishment timing, browse multiple electronic commerce platforms, and compare prices and purchase options. Such manual operations impose a cognitive burden on the user, often result in missed optimal purchase timing, and make it difficult to take advantage of temporary discounts or favorable market conditions. Furthermore, existing systems do not adequately utilize statistical analysis of purchase history data together with machine learning techniques to predict purchase timing or to optimize purchase decisions. In addition, conventional systems do not automatically generate tailored proposal messages by using generative AI models and deliver them to the user through a communication application in a natural, user-friendly manner. Accordingly, there is a need for a system that links communication applications and electronic commerce platforms, automatically learns user purchase patterns, determines optimal purchase timing and price, and generates and sends appropriate proposal messages to the user, thereby reducing user effort and improving purchasing efficiency.

### SUMMARY

To solve the above-described problems, an aspect of the present invention provides a system comprising a processor, wherein the processor is configured to acquire account information of a user in order to associate identification information of a communication application with identification information of an electronic commerce platform, and to store the account information in a database. The processor is further configured to receive, through a user interface provided via the communication application or a terminal, information on an article that the user purchases periodically, and to record the information in the database. The processor is configured to acquire past purchase history data, to analyze the past purchase history data by using a statistical method, and to calculate a purchase frequency of the article. The processor is also configured to acquire price information in real time from a plurality of electronic commerce platforms and to calculate an optimal price by using a comparison algorithm. Based on an analysis result including at least the calculated purchase frequency and the optimal price, the processor is configured to calculate a purchase timing and to notify the user of the purchase timing through the communication application. Furthermore, the processor is configured to create a prompt sentence for generating a proposal sentence by a generative AI model, to input the prompt sentence into the generative AI model to generate the proposal sentence, and to transmit the generated proposal sentence to the user through the communication application. In some embodiments, the processor is configured to learn a purchase pattern by using a machine learning algorithm based on a purchase history of the user and to predict a next purchase timing, and to present an optimal purchase option by taking into account a past purchase history of the user and a current market price.

The term “processor” refers to a hardware and/or software component, such as a central processing unit (CPU), microcontroller, application-specific integrated circuit (ASIC), programmable logic device, or a combination thereof, that executes programmed instructions to perform the functions described in the claims.

The term “communication application” refers to an application or service that enables electronic message exchange between users and/or systems, including but not limited to messenger applications, chat applications, email clients, social networking applications, and platforms providing chatbot or messaging interfaces.

The term “electronic commerce platform” refers to an online service, website, or system that enables users to browse, select, and purchase goods or services over a network, and that provides order processing, payment processing, and order history management functions.

The term “identification information” refers to data used to uniquely or distinctively identify an entity such as a user, an account, a communication application, or an electronic commerce platform, including, for example, user IDs, account IDs, tokens, handles, or other identifiers. The term “account information” refers to information associated with a user account on a communication application or an electronic commerce platform, including, for example, account identifiers, authentication tokens, profile information, and link information used for association between different services.

The term “database” refers to any structured data storage system, including relational databases, NoSQL databases, key-value stores, or other data repositories, that stores and manages account information, article information, purchase history data, and related records for the system.

The term “user interface” refers to any interface through which a user interacts with the system, including graphical user interfaces, command-line interfaces, web interfaces, and conversational interfaces provided via a communication application or terminal.

The term “article” refers to a good, product, commodity, or consumable item that can be purchased by the user through an electronic commerce platform, including items that are purchased periodically or repeatedly.

The term “purchase history data” refers to data representing past purchases of articles by the user, including, for example, purchase dates, quantities, prices, article identifiers, and electronic commerce platform identifiers.

The term “statistical method” refers to any analytical technique based on statistics, including, for example, computation of averages, medians, variances, distributions, regressions, or other quantitative measures used to analyze purchase history data and derive purchase frequency or patterns.

The term “purchase frequency” refers to an estimated or calculated measure of how often a user purchases a particular article, expressed, for example, as an average interval of days between purchases or as a rate over a specified time period.

The term “price information” refers to data related to the selling price of an article on an electronic commerce platform, including base price, discount information, shipping fees, taxes, and other cost-related parameters.

The term “comparison algorithm” refers to a procedure or set of rules executed by the processor to compare price information, conditions, and other parameters across multiple electronic commerce platforms in order to determine an optimal or preferred price or option.

The term “optimal price” refers to a price for an article determined by the system as preferable according to one or more criteria, such as the lowest effective price, best discount, or best value when considering shipping fees, taxes, and other conditions.

The term “purchase timing” refers to a point in time or a time period determined by the system as suitable or recommended for purchasing an article, based on factors such as purchase frequency, predicted need, and price information.

The term “generative AI model” refers to a machine learning model, such as a neural network-based language model or other generative model, that is configured to generate natural language text or other output in response to input data or prompts.

The term “prompt sentence” refers to text or structured input data provided to a generative AI model, specifying conditions, context, or instructions for generating a proposal sentence or other output.

The term “proposal sentence” refers to a generated text message or content that includes a recommendation, suggestion, or explanation regarding purchase timing, price, or purchase options, and that is intended to be presented to the user.

The term “machine learning algorithm” refers to an algorithm or model that enables a computer system to learn patterns from data, including supervised, unsupervised, or reinforcement learning techniques, and that is used to infer user purchase patterns and predict future purchase behavior.

The term “purchase pattern” refers to a relationship or trend in a user's purchasing behavior over time, such as typical intervals between purchases, preferred platforms, typical quantities, or responses to price changes, as inferred from purchase history data.

The term “next purchase timing” refers to a predicted future time or time window at which the user is likely to need or perform a purchase of a given article, as estimated by the system based on purchase history data and learned purchase patterns.

The term “current market price” refers to a price or price range for an article at or near the present time, obtained from one or more electronic commerce platforms, and optionally including ongoing discounts, promotions, or dynamic pricing conditions.

The term “optimal purchase option” refers to a recommendation comprising at least one of an electronic commerce platform, a price, a purchase timing, or a combination thereof, determined as preferable for the user based on past purchase history, current market price, and other criteria.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

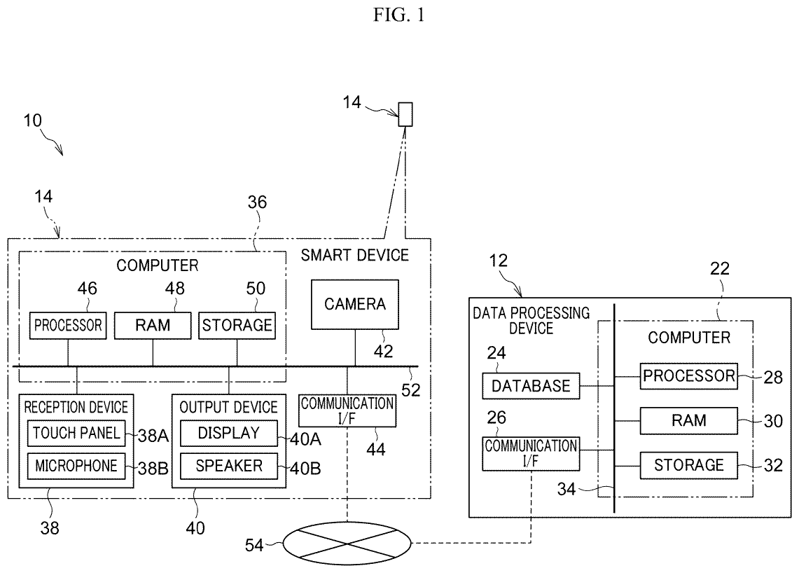

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

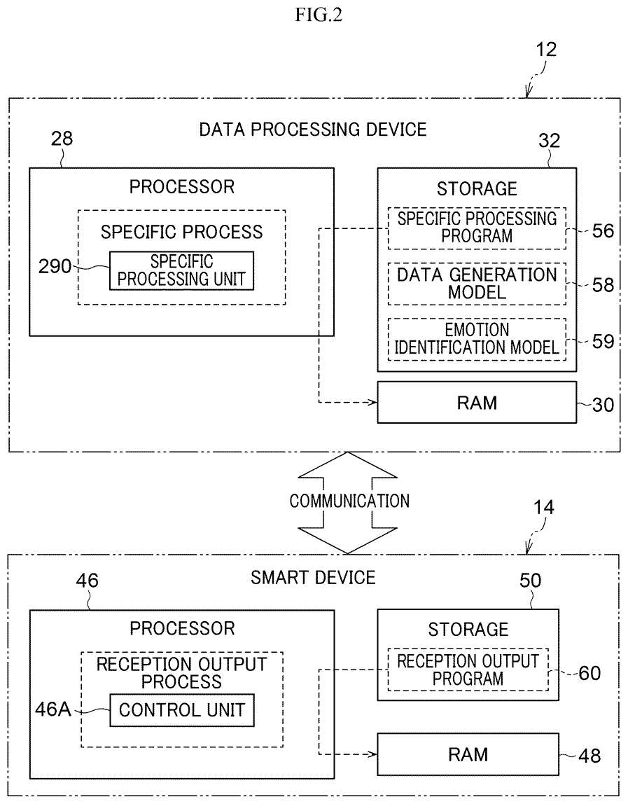

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented reminder and recommendation systems for periodic purchases generally rely on fixed rules or simple threshold triggers to decide when and how to notify a user. In such systems, a processor typically retrieves historical purchase data, computes a next reminder date using static interval logic, and sends a pre-defined template message. These architectures exhibit several technical limitations at the level of data processing, model interfacing, and message generation on the server side.

First, existing systems do not flexibly integrate heterogeneous data sources, such as time-series purchase history, multi-source pricing and availability information from multiple transaction platforms, and user-specific behavioral responses to past notifications, into a unified data structure that is usable in a real-time manner. As a result, the processor often performs repetitive query and formatting operations, increases network traffic and storage access overhead, and introduces latency and inconsistency in determining reminder timing and content.

Second, when generative AI models are used, conventional implementations typically submit only coarse or generic prompts to such models, without systematically encoding computed schedule information, dynamic price and availability changes, and user-specific preference patterns into the prompt sentence. This leads to suboptimal utilization of the generative AI model, since the model receives incomplete contextual information, and the server must compensate by performing additional post-processing or by sending multiple queries. This increases processing time, consumes additional computational resources, and makes it difficult to guarantee consistent output formats required by downstream communication functions.

Third, many known systems lack an integrated feedback mechanism by which the server can update, in a machine-assisted and data-driven manner, the configuration conditions for prompt construction and the generation conditions for proposal text data based on transmission history and subsequent transaction outcomes. Without such a mechanism, the system cannot improve the relevance of generated messages or adapt its computational behavior (for example, model input parameters, content structure, or trigger thresholds) to changing user behavior and market conditions. This results in inefficient use of processor cycles and storage bandwidth and limits the scalability and responsiveness of the system. Fourth, conventional architectures often treat schedule-based reminders and price- or stock-driven alerts as separate subsystems, each with its own triggers and message generation logic. This separation forces the processor to maintain redundant state, run parallel scheduling routines, and reconcile conflicting notifications at the communication layer. Consequently, the server incurs unnecessary computation and memory usage and may cause duplicative messages or inconsistent user experiences.

Accordingly, there is a need for an improved computer-implemented system and server-side processing method that (i) unifies schedule information, multi-source evaluation index data, and user behavior history into a coherent control flow, (ii) constructs prompt sentences for a generative AI model in a structured and dynamic way that explicitly encodes such information, (iii) formats and delivers generated proposal text data in a way that is directly consumable by a communication function and a transaction function, and (iv) employs a feedback loop to continuously adjust prompt configuration and message generation conditions. Such improvements at the system and processor level can reduce redundant processing, lower latency, improve resource utilization, and enhance the overall technical performance of the server in generating and delivering personalized reminder and recommendation messages.

The specific processing by the specific processing unit 290 of the data processing device 12 in Example 1 is realized by the following means.

The present invention provides a server comprising a processor and a storage device, wherein the processor is configured to associate identification information between a communication function and a transaction function by acquiring authentication information of a user, storing the authentication information in the storage device, and performing connection control using an authentication scheme based on the authentication information; to receive, via a user interface of a terminal device, input information regarding target data that the user desires to periodically obtain and setting information regarding an acquisition interval, and to register the input information and the setting information in the storage device as time-series management data; to acquire history data accumulated in the storage device, to calculate an acquisition frequency and an acquisition tendency of the target data by using at least one of a time-series analysis method and a statistical analysis method, and to generate acquisition schedule information including a next scheduled acquisition time; to receive evaluation index data dynamically obtained from a plurality of transaction functions via a communication path, to extract price information and availability information included in the evaluation index data, and to derive optimal acquisition candidate information by a comparison processing algorithm; to construct a prompt sentence in a natural language for input to a generative information processing model on the basis of the acquisition schedule information and the optimal acquisition candidate information, and to dynamically generate the prompt sentence by embedding, into the prompt sentence, at least a name of the target data, the scheduled acquisition time, and a price condition and a discount condition based on the evaluation index data; to transmit, to the generative information processing model, input data including the prompt sentence, to receive proposal text data generated by the generative information processing model, and to format a length, an expression style, and an output format of the proposal text data according to predetermined conditions; to generate notification message data by combining the formatted proposal text data with identifiers, date and time information, and destination information included in the acquisition schedule information and the optimal acquisition candidate information, to transmit the notification message data to the terminal device via a notification interface of the communication function, and to record transmission history of the notification message data in the storage device; to transmit, to the transaction function, a transaction request according to an operation instruction from the terminal device by using the destination information included in the notification message data, to acquire response data to the transaction request, to register the response data as additional history data in a history database of the storage device, and to update the acquisition schedule information based on the response data; and to execute, at predetermined intervals, an evaluation process for updating a configuration condition of the prompt sentence or a generation condition of the proposal text data on the basis of the history data and the transmission history, and to reflect a result of the evaluation process in subsequent prompt sentence generation processing and notification message generation processing. This enables the server to improve computer operation by unifying schedule management, multi-source evaluation index processing, and generative model interaction within a single feedback-controlled workflow, thereby reducing redundant computations, lowering end-to-end latency for generating personalized proposal messages, and enhancing the efficiency and adaptability of the communication and transaction processing performed by the server.

The term “system” refers to an arrangement of one or more hardware devices and software components that cooperate to execute information processing, including at least a processor and a storage device configured to perform the claimed operations.

The term “server” refers to a computing apparatus, which may be a physical machine or a virtual machine, including at least one processor and a storage device, configured to provide communication, transaction, and data processing services to one or more terminal devices via a network.

The term “processor” refers to one or more hardware processing units, such as a central processing unit or a processing core, configured to execute instructions and perform arithmetic, logical, control, and input/output operations according to program code. The term “storage device” refers to any non-transitory computer-readable medium, such as a semiconductor memory, magnetic storage, or optical storage, configured to store data and program code used by the processor.

The term “terminal device” refers to an end-user computing device, such as a portable terminal or a stationary terminal, including an input unit and a display unit, used by a user to interact with the server via a communication network.

The term “communication function” refers to a software-controlled communication capability, executed by the server or by a service associated with the server, that transmits and receives messages, notifications, and data between the server and a terminal device over a communication network.

The term “transaction function” refers to a software-controlled processing capability, executed by the server or by an external service, that processes a transaction request, including at least selection, ordering, or acquisition of target data, and returns response data indicating a transaction result.

The term “identification information” refers to information used to uniquely or semi-uniquely distinguish an account, device, or service endpoint, including at least an account identifier, a user identifier, or a session identifier.

The term “authentication information” refers to information used to verify the identity or authority of a user or a device, including at least credentials, tokens, or keys used in an authentication scheme.

The term “authentication scheme” refers to a protocol or method for verifying authentication information, including at least token-based authentication, key-based authentication, or password-based authentication.

The term “connection control” refers to a process executed by the processor to establish, maintain, or terminate a logical or physical communication session between the communication function and the transaction function based on authentication information.

The term “user interface” refers to a software-controlled interface presented on a terminal device, including at least a graphical interface, a text-based interface, or a voice-based interface, through which a user provides input information and receives output information. The term “target data” refers to information or content representing an item, service, or resource that a user desires to obtain periodically or repeatedly via the transaction function. The term “acquisition interval” refers to temporal setting information indicating a period or rule specifying how often or when target data is to be acquired, including at least an interval length or a scheduled date and time.

The term “time-series management data” refers to data stored in the storage device that represents target data, acquisition intervals, and related temporal attributes in a form suitable for time-based computation and scheduling.

The term “history data” refers to data representing past events related to target data, including at least past acquisition times, transaction results, and message transmission records, stored in the storage device.

The term “acquisition frequency” refers to a quantitative measure derived from history data that indicates how often the target data has been acquired over a specified time period. The term “acquisition tendency” refers to a pattern or trend in acquisition behavior derived from history data, including at least preferred acquisition times, preferred conditions, or changes over time.

The term “acquisition schedule information” refers to data calculated by the processor that defines one or more future times or conditions for acquiring target data, including at least a next scheduled acquisition time.

The term “evaluation index data” refers to data acquired from one or more transaction functions that provides quantitative or qualitative indicators related to target data, including at least price information and availability information.

The term “price information” refers to numerical data indicating a cost associated with the acquisition of target data, including at least base price, discount price, or total cost. The term “availability information” refers to data indicating whether and under what conditions target data can be acquired, including at least stock status, delivery conditions, or service status.

The term “comparison processing algorithm” refers to a computational procedure executed by the processor to compare multiple sets of evaluation index data and to determine one or more optimal candidates based on predefined criteria.

The term “optimal acquisition candidate information” refers to information derived by the comparison processing algorithm that identifies one or more preferred acquisition options for target data, based on evaluation index data and selection criteria.

The term “generative information processing model” refers to a computational model, such as a generative AI model or a large language model, configured to generate text or other content in response to input data including a prompt sentence.

The term “prompt sentence” refers to a natural-language or structured text prepared by the processor as part of input data to the generative information processing model, the prompt sentence specifying instructions, context, and constraints for generating output content. The term “proposal text data” refers to text output generated by the generative information processing model in response to the prompt sentence, the text providing a proposal, recommendation, or notification to be delivered to a user.

The term “expression style” refers to stylistic characteristics of proposal text data, including at least tone, formality level, politeness level, or grammatical structure.

The term “output format” refers to structural characteristics of proposal text data as used in a communication function, including at least text length, segmentation, and compatibility with a messaging protocol.

The term “notification message data” refers to a data structure generated by the processor that encapsulates proposal text data together with associated identifiers, date and time information, and destination information for transmission via the communication function. The term “identifier” refers to a symbol or code included in notification message data or schedule information that uniquely or semi-uniquely denotes a user, a transaction, target data, or a message instance.

The term “date and time information” refers to data that specifies a point or interval in time, including at least a date, a clock time, or a timestamp.

The term “destination information” refers to data used by the communication function or the transaction function to route a message or a transaction request to a target endpoint, including at least an address, an account reference, or a resource locator.

The term “transmission history” refers to a record stored in the storage device indicating that notification message data or other data has been transmitted, including at least a transmission time, a destination, and a message identifier.

The term “history database” refers to a logical or physical data store within the storage device in which history data, including transaction results and transmission history, is accumulated and managed.

The term “transaction request” refers to a request message generated by the processor and sent to the transaction function, instructing the execution of a transaction related to target data based on an operation instruction from the terminal device.

The term “response data” refers to data returned by the transaction function in reply to a transaction request, including at least a result status, transaction details, or updated target data information.

The term “evaluation process” refers to a process periodically executed by the processor to analyze history data and transmission history, to compute one or more performance metrics, and to update configuration conditions or generation conditions used in subsequent processing.

The term “configuration condition of the prompt sentence” refers to parameters or rules used by the processor when constructing the prompt sentence, including at least content selection rules, length constraints, and styling instructions.

The term “generation condition of the proposal text data” refers to parameters or rules that influence the behavior of the generative information processing model or the post-processing of its output, including at least desired tone, allowed length, and emphasis points.

The term “machine learning method” refers to a computational technique in which a model or algorithm is trained or adapted based on sample data, enabling the processor to infer patterns or predictions, such as acquisition patterns for each user.

The term “acquisition pattern” refers to a pattern learned by the processor using a machine learning method that represents the temporal and contextual characteristics of how a user tends to acquire target data.

The term “attribute information” refers to descriptive data related to a user or target data, including at least demographic attributes, category attributes, or historical behavior attributes. The term “preference information” refers to data representing a user's preferences inferred or specified, including at least preferred timing, preferred providers, preferred price ranges, or preferred communication styles.

The term “price fluctuation” refers to a change over time in price information determined from evaluation index data for target data.

The term “availability fluctuation” refers to a change over time in availability information determined from evaluation index data for target data.

The term “threshold” refers to a predetermined value used to determine whether a detected price fluctuation or availability fluctuation is sufficiently large to trigger generation of additional prompt sentences or notifications.

The term “additional prompt sentence” refers to a prompt sentence generated independently of regularly scheduled acquisition times, in response to a detected price fluctuation or availability fluctuation exceeding a threshold.

The term “communication network” refers to a wired or wireless network over which data is transmitted between the server, transaction functions, and terminal devices, including at least public networks, private networks, or combinations thereof.

In one embodiment, a server includes at least one processor, a main memory, a non-transitory storage device, and a network interface. The server is connected via a communication network to one or more terminal devices operated by users. Each terminal includes an input unit, a display unit, a local memory, and a communication module. The server executes a plurality of software modules including a communication module, a schedule management module, an evaluation index processing module, a generative model interface module, a notification generation module, a transaction interface module, and a feedback learning module. The server further cooperates with an external generative AI model executing on the same physical machine, on a dedicated accelerator device, or on a remote computing node.

The server uses, as an example of hardware configuration, a general-purpose computing platform comprising a multi-core central processing unit, a graphics processing unit or other accelerator, a volatile memory such as random access memory, a non-volatile memory such as a solid-state drive, and a network interface controller supporting Internet Protocol-based communication. The server runs an operating system, such as a general-purpose server operating system, and provides application services using a software framework such as a web application framework or a microservice framework.

The terminal uses a mobile operating system or a desktop operating system and executes a communication application. The terminal provides a graphical user interface that enables the user to input information regarding items to be periodically acquired and to receive proposal messages generated by the server. The terminal exchanges data with the server using secure communication protocols such as HTTPS, and encapsulates user input in structured messages defined by an application-layer protocol.

The server stores, in the storage device, a plurality of data structures. In one embodiment, the server maintains a user table that stores user identifiers, communication identifiers, transaction identifiers, and authentication information. The server maintains a schedule table that stores, for each user and each target data instance, a target identifier, a description, an acquisition interval, a next scheduled acquisition time, and metadata indicating schedule status. The server further maintains an evaluation index table that stores, for each target identifier and each transaction provider, price information, availability information, and additional evaluation indices. The server also maintains a history database that stores history data including transaction history records and transmission history records for notification messages.

The server associates a communication function and a transaction function by storing in the user table identification information and authentication information received from the terminal. The server obtains authentication tokens or equivalent authentication information from external transaction systems and records token values, validity periods, and refresh parameters. By maintaining these fields in a structured storage, the server reduces repeated authentication exchanges and lowers communication load during subsequent transaction execution.

The server registers target data and acquisition intervals as time-series management data. The server receives, from the terminal, text input such as “toilet paper, buy every month on the 1st” or “coffee beans, buy every 3 weeks,” and converts the text into a normalized data record. For example, the server maps the item name to a target identifier, converts the interval description into a numeric representation such as “interval_type=monthly” and “interval_value=1,” and computes an initial next scheduled acquisition time using time arithmetic functions provided by a runtime library. The server stores these values in the schedule table. By using normalized interval representation and precomputed next scheduled times, the server can evaluate future acquisition timing with reduced computational overhead. The server acquires history data from the history database and performs computational analysis to derive acquisition frequency and acquisition tendency. In one embodiment, the server represents history data as a time series of acquisition events with timestamps and quantities. The server then applies time-series analysis techniques such as moving average computation, exponential smoothing, or periodicity detection to determine how often and under what conditions each user acquires each target. The server also applies statistical analysis methods such as frequency histograms and correlation analysis to determine how price changes or message timing correlate with actual acquisitions. These computations are implemented as vectorized operations on arrays or as set-based operations using relational queries. Because the server maintains history in a normalized table structure with indexed timestamp fields, the server can perform these computations efficiently, thereby improving processing speed compared to systems that scan unstructured logs.

The server acquires evaluation index data from a plurality of transaction functions. The server sends requests to external transaction systems, receives responses including candidate offers, and stores selected fields into the evaluation index table. In one embodiment, the server periodically polls multiple providers and merges results into a unified record keyed by target identifier and provider identifier. The server then executes a comparison algorithm that ranks offers based on multiple criteria such as minimum price, maximum discount ratio, and availability constraints. The server may compute a weighted score for each offer using a configurable scoring function that combines normalized price, discount, and delivery time. By storing these scores in the evaluation index table and indexing them by target and time, the server can quickly identify an optimal acquisition candidate for each schedule entry without recomputing metrics for all offers.

The server constructs a prompt sentence for a generative AI model through a generative model interface module. The server receives, from the schedule management module, acquisition schedule information including the next scheduled acquisition time, and receives, from the evaluation index processing module, optimal acquisition candidate information including a selected provider, a current price, and discount conditions. The server then populates a prompt template with these values to produce a prompt sentence. The prompt template encodes both instructions to the generative AI model and structured context representing the current state of schedule, price, and user preferences.

For example, the server may generate the following prompt sentence for a particular user and item:

“Today is one day before the user's scheduled purchase of toilet paper. The user usually buys 24 rolls. The current best offer is 980 yen for 24 rolls with free shipping at a selected store. Generate a short, polite reminder message in English encouraging the user to purchase now. Mention that tomorrow is the scheduled purchase date and that the current price is favorable. Output a single sentence.”

In another case, the server may generate the following prompt sentence:

“The user buys 1 kilogram of coffee beans every three weeks. Today is two days before the next scheduled date. Market prices have decreased by 10% compared to last week. Generate a friendly and concise reminder message in English telling the user that this is a good opportunity to buy coffee beans at a lower price. Include the discount information and keep the message within 2 sentences.”

The server transmits such prompt sentences to a generative AI model that is implemented, for example, as a transformer-based neural network. In one embodiment, the generative AI model includes multiple layers of self-attention and feed-forward networks. The model receives as input a sequence of tokens obtained by tokenizing the prompt sentence using a subword tokenizer. The model computes contextual representations by applying self-attention heads that compute weighted sums of token embeddings, where the weights are determined by similarity between query and key vectors. The model then generates output tokens by computing probability distributions over a vocabulary using a softmax function applied to linear projections of final-layer embeddings. The model selects tokens according to decoding parameters such as temperature and top-k or nucleus sampling thresholds.

In a training phase that may be performed offline or in a separate environment, the generative AI model is optimized using a loss function such as cross-entropy between predicted tokens and reference tokens. The model updates its internal weights using gradient-based optimization, such as stochastic gradient descent with momentum or an adaptive optimizer. During training, the model may use data augmentation such as random truncation or noise injection in prompts to improve robustness. These techniques allow the server, when calling the trained model, to obtain coherent proposal text data with high consistency and low error rate relative to desired output patterns.

The server formats the proposal text data returned by the generative AI model. The server trims extraneous whitespace, enforces a maximum length measured in characters or tokens, and applies regular expressions to verify that required semantic elements, such as item name and time reference, appear in the generated text. If the proposal text does not satisfy predefined structural constraints, the server can adjust the prompt sentence or apply deterministic post-processing rules, such as appending missing time information from acquisition schedule information. This structured post-processing reduces the need for multiple model calls and provides stable message formats that integrate reliably with the communication function.

The server generates notification message data by combining the formatted proposal text data with identifiers, date and time information, and destination information. The notification generation module retrieves user identifiers and communication identifiers from the user table, retrieval schedule information from the schedule table, and destination addresses or endpoints from configuration records. The server assembles these fields into a message object conforming to the communication protocol of the terminal-side application. The server records each notification in a transmission history table with a timestamp and a message identifier. Because the server maintains a transmission history, it can avoid sending duplicate notifications for the same schedule event and can later analyze correlations between message issuance and transaction outcomes.

The server transmits transaction requests using the transaction interface module. When the user operates the terminal to invoke a purchase or other transaction based on a received proposal message, the terminal sends a command to the server indicating the selected target and action. The server uses destination information stored in relation to the optimal acquisition candidate to construct a transaction request that includes a target identifier, a quantity, and authentication tokens. The server sends this request to the transaction function, receives response data including success status and transaction details, and registers a new record in the history database. The server then updates acquisition schedule information by computing a new next scheduled time using the time interval rules associated with the target.

This update ensures that schedule information stays synchronized with actual user activity.

The server executes an evaluation process implemented by the feedback learning module.

The server periodically aggregates history data and transmission history to compute performance indicators, such as the rate at which received proposal messages lead to completed transactions, the distribution of purchase times relative to recommended times, and the sensitivity of users to price fluctuations. The server then adjusts configuration conditions used for prompt construction and for generative AI model invocation. For instance, if the server observes that messages emphasizing price decrease produce higher engagement, the server increases weights for discount information in the scoring function and modifies prompt templates to emphasize savings. The server may also alter maximum length constraints or tone descriptors in prompt sentences, in order to match user response patterns derived by a machine learning method.

In one embodiment, the server applies a machine learning algorithm such as a gradient-boosted decision tree or a recurrent neural network to learn acquisition patterns for each user.

The server constructs feature vectors that include temporal features (such as day-of-week and hour-of-day), price features (such as relative discount), and message features (such as message length and tone indicators). The server trains the model on historical records to predict probabilities of user actions, such as purchase within a given time window after a notification. The server uses the trained model to select or parameterize prompt templates. This configuration allows the server to adapt to user behavior in a manner that is not achievable by static rule sets, thereby improving accuracy and reducing unnecessary notifications.

The server achieves technical effects by virtue of the integrated data structures and algorithmic processing described above. By consolidating schedule information, evaluation indices, and history data in indexed relational structures, the server reduces redundant queries and avoids repeated parsing of raw log data. By constructing prompt sentences that explicitly encode schedule times, price conditions, and user preferences, the server reduces the number of model invocations required to obtain usable proposal text data and decreases overall processing time. By applying structured post-processing and format enforcement, the server minimizes downstream errors in communication protocols and reduces re-transmissions. By implementing a feedback learning loop that modifies prompt configuration and scoring criteria based on observed performance, the server continuously improves computational efficiency, reduces the number of messages that do not result in user action, and focuses processor load on high-value operations.

The server thus does more than merely automate human decision-making. The server modifies how data is represented, scheduled, and routed inside computing hardware, improves the efficiency of calls to a generative AI model, and restructures communication flows between the server and transaction systems. These architectural features and algorithmic strategies yield measurable improvements in processing speed, storage utilization, and communication bandwidth consumption, thereby constituting an improvement to computer technology.

In a variation, the server may host the generative AI model locally on an accelerator device instead of accessing an external service. In that case, the server loads model weights from the storage device into accelerator memory, partitions input batches for parallel processing, and uses a custom inference engine to perform token generation. The server may apply quantization or pruning techniques to reduce memory footprint and accelerate inference. These techniques further reduce latency in generating proposal text data and enable real-time notification generation even under high user load.

In another embodiment, the server may support multiple generative AI models of different sizes or capabilities and select a model according to the complexity of the prompt sentence or the required response time. For example, the server may select a smaller model when generating routine reminders with simple content, and a larger model when generating complex proposals involving multiple items and constraints. This dynamic model selection is based on metrics such as available computation resources and target latency. By switching models according to context, the server balances quality and speed more efficiently than would be possible with a fixed single-model configuration.

In yet another embodiment, the server may store, for each user, a profile of preferred language, tone, and message length. The server then modifies prompt sentences to include explicit instructions such as “use a casual tone” or “keep within one sentence” tailored to the profile. The server also maintains counters of user interactions with messages having different tones or lengths. Over time, the server updates profile values based on interaction data using a reinforcement-learning-like update rule. This per-user adaptation is implemented at the level of prompt construction and message formatting, rather than at the level of business logic, and therefore directly optimizes computational resources used in generating and transmitting messages.

The terminal operates as an interface between the user and the server. The terminal displays proposals received from the server, renders them using native user interface components, and provides interactive elements such as buttons for executing transactions or modifying schedules. The terminal relays user commands as structured messages to the server, without performing heavy computation itself. This offloading of intensive tasks to the server enables the system to serve a large number of terminals while centralizing complex data analysis and generative model processing in a hardware environment optimized for such tasks.

The user participates in the system by initially providing account information for communication and transaction functions, by defining target data and acquisition intervals, and by responding to proposal messages. The user may modify settings at any time through the terminal, and the server records these changes and updates data structures accordingly.

The user does not need to manage detailed schedules or compare prices manually, because the server continuously measures, predicts, and optimizes acquisition timing and proposal content using the integrated processing framework described above.

Through these embodiments and variations, the system realizes a technical solution that tightly couples schedule computation, multi-source evaluation index processing, generative AI model interaction, and feedback learning within a server-controlled architecture, thereby improving computer operation in terms of processing speed, accuracy of generated proposals, reduction of communication overhead, and robustness of data management.

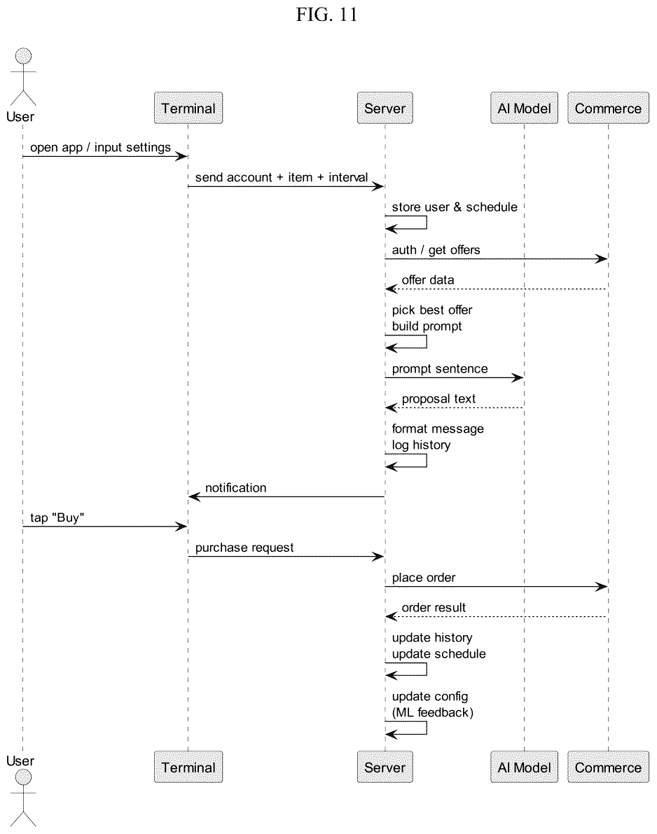

The following describes the processing flow using FIG. 11.

### Step 1:

Server receives account association input.

Server receives, from the terminal, input including communication account information and transaction account information entered by the user (input: user identifiers, account IDs, authentication tokens). Server validates the authentication tokens by sending verification requests to external authentication endpoints and checking response codes and expiration times (data processing: format checking, cryptographic token validation, timestamp comparison). Server then stores normalized identification information and authentication information into a user table in the storage device, linking communication identifiers with transaction identifiers (output: stored user record with associated IDs and valid token metadata).

### Step 2:

Terminal presents periodic acquisition setting interface.

Terminal displays, to the user, an input screen of the communication application showing fields for target item name, quantity, and acquisition interval (input: current user profile and UI configuration). Terminal collects the user's textual inputs such as “toilet paper,” “24 rolls,” and “every month on the 1st,” converts them into a structured message object (data processing: parsing free-text, mapping to key-value pairs), and transmits the structured message to the server via a network protocol (output: structured schedule-setting request sent to the server).

### Step 3:

Server registers time-series management data.

Server receives the structured schedule-setting request from the terminal (input: item name, quantity, acquisition interval type and value, user ID). Server normalizes the item name by mapping it to an internal target identifier and unit description, and converts interval expressions into numeric values (data processing: string normalization, lookup in item master table, conversion of “every month on the 1st” into interval_type=monthly, interval_value=1, day_of_month=1). Server calculates an initial next scheduled acquisition time using calendar arithmetic based on the current time and the interval specification, and inserts a new record into a schedule table with user ID, target ID, quantity, interval, and next scheduled time (output: new schedule entry stored as time-series management data).

### Step 4:

Server acquires and updates history data.

Server retrieves existing transaction history and notification history associated with the user and the target from the history database (input: user ID, target ID). Server aggregates timestamps and quantities to form a chronological sequence of acquisition events and notification events (data processing: database query, sorting by timestamp, grouping by target). Server stores an updated history snapshot for internal analysis, including derived fields such as total purchases, average interval between purchases, and notification-to-purchase lag (output: computed history summary stored for later analysis).

### Step 5:

Server computes acquisition frequency and tendency.

Server takes the chronological acquisition events from history as input (input: list of timestamps and quantities per target). Server performs time-series computations such as counting events in fixed windows, computing moving averages, and estimating periodicity (data processing: sliding-window aggregation, mean and variance computation, peak detection over time indices). Server computes an acquisition frequency value (e.g., purchases per month) and an acquisition tendency profile (e.g., preferred days or times, sensitivity to past discounts), and registers these values into associated fields of the schedule table or a separate analysis table (output: acquisition frequency and tendency parameters linked to each schedule).

### Step 6:

Server collects evaluation index data from transaction functions.

Server generates requests to multiple external transaction systems using stored authentication information (input: target identifier, user preferences, provider endpoints, authentication tokens). Server sends search queries including the normalized item name or category, desired quantity, and optional filters, and receives responses containing multiple candidate offers in structured form (data processing: HTTP communication, JSON parsing). Server extracts evaluation index data, specifically price information, discount information, and availability information for each candidate, and stores these records in the evaluation index table with provider identifiers and timestamps (output: updated evaluation index records for each target and provider).

### Step 7:

Server derives optimal acquisition candidate information.

Server retrieves, from the evaluation index table, all current offers for a given target and user (input: target ID, evaluation index records). Server applies a comparison processing algorithm that computes, for each offer, a score based on price, discount, delivery time, and availability (data processing: normalization of price and discount into dimensionless values, weighted sum calculation, filtering out unavailable offers). Server selects the offer with the highest score or a small set of top-ranked offers as optimal acquisition candidate information and stores the selection result in association with the schedule entry (output: optimal acquisition candidate record containing selected provider, current price, discount, and availability).

### Step 8:

Server constructs a context-rich prompt sentence.

Server obtains acquisition schedule information and optimal acquisition candidate information for a given user and target (input: next scheduled acquisition time, target description, selected provider and price, discount conditions, user preference profile). Server then fills a prompt template with these values through string substitution or templating (data processing: concatenation, insertion of variables, formatting of dates and currency values into natural language). For example, server may generate:

“Today is one day before the user's scheduled purchase of toilet paper. The user usually buys 24 rolls. The current best offer is 980 yen for 24 rolls with free shipping at a selected store. Generate a short, polite reminder message in English encouraging the user to purchase now. Mention that tomorrow is the scheduled purchase date and that the current price is favorable. Output a single sentence.”

The constructed text is stored as a prompt sentence associated with the current schedule instance (output: finalized prompt sentence ready for submission to a generative AI model).

### Step 9:

Server sends prompt sentence to generative AI model and receives proposal text. Server transmits the prompt sentence and optional control parameters, such as desired temperature and maximum token count, to a generative AI model endpoint (input: prompt sentence, model parameters). Server initiates an inference call, where the model tokenizes the prompt and generates output tokens according to its internal neural network parameters (processing external to the server's CPU), then receives the generated text as proposal text data (data processing on server side: HTTP request/response handling, extraction of generated text field). Server stores the raw proposal text data in a prompt log along with the corresponding prompt sentence and user identifiers (output: unformatted proposal text stored for further processing).

### Step 10:

Server formats and validates proposal text data.

Server takes the generated proposal text as input (input: raw proposal text, formatting rules, structural constraints). Server trims leading and trailing whitespace, truncates the text if it exceeds a configured maximum length, and checks for required semantic tokens such as item name, time reference (“tomorrow,” “next week”), or price reference by applying pattern-matching rules (data processing: length check, regular expression matching, token presence verification). If mandatory elements are missing, server may append or insert the necessary information using schedule and evaluation index data (e.g., inserting “tomorrow is your scheduled purchase day”). Server outputs a formatted proposal sentence that satisfies both content and structural rules (output: validated and formatted proposal text data).

### Step 11:

Server generates notification message data.

Server retrieves user communication identifiers and destination information from the user table and schedule table (input: user ID, communication ID, formatted proposal text, acquisition schedule information, optimal acquisition candidate information). Server constructs a notification message object that encapsulates the proposal text, a hyperlink or identifier for executing a transaction, and metadata such as the schedule ID and timestamp (data processing: serialization of fields into a protocol-specific message format). Server records the notification message details in a transmission history table with send time and message ID (output: notification message data ready for transmission and logged transmission record).

### Step 12:

Server sends notification and terminal displays message.

Server transmits the notification message data to the communication function associated with the terminal (input: notification message object, destination information). Server receives a delivery acknowledgment or message ID from the communication platform and updates the transmission history accordingly (data processing: network transmission, acknowledgment handling). Terminal receives the notification, parses the message payload, and renders the proposal text and controls (such as “Buy now” button) on the display (output: visible reminder message on the terminal with actionable elements).

### Step 13:

User interacts with the proposal and initiates a transaction.

User reads the reminder on the terminal and selects a control element, such as tapping “Buy now” (input: displayed message, interactive elements). Terminal translates the user action into a structured command, including schedule ID or target ID and desired quantity, and sends this command to the server (data processing: mapping UI event to a request object, attaching session credentials). Terminal outputs a transaction initiation request to the server (output: transaction command message addressed to the server).

### Step 14:

Server constructs and sends transaction request to transaction function.

Server receives the transaction command from the terminal (input: user ID, target ID, schedule ID, optional quantity override). Server uses stored authentication information and optimal acquisition candidate data to assemble a transaction request that includes the selected provider's endpoint, item identifier, price, and quantity (data processing: retrieval of stored tokens, mapping internal target ID to provider-specific product ID, building request payload). Server transmits this request to the transaction function and waits for response data (output: external transaction request sent and pending response).

### Step 15:

Server processes transaction response and updates history and schedule.

Server receives response data from the transaction function (input: response code, transaction details such as confirmation ID, final price, and completion time). Server validates the response by checking success indicators and consistency of item and quantity fields (data processing: field comparison, error detection). Server writes a new transaction record into the history database, including timestamp, item, quantity, price, and provider, and recalculates the next scheduled acquisition time using the acquisition interval rules (data processing: time arithmetic adding interval to the actual purchase time, update of schedule table fields). Server marks the corresponding schedule instance as completed and updates its status and next scheduled date (output: updated history data and schedule information reflecting the completed transaction).

### Step 16:

Server performs feedback evaluation and adjusts prompt and generation conditions.

Server periodically retrieves accumulated history data and transmission history for each user and target (input: transaction records, notification send records, user interaction outcomes).

Server computes performance metrics such as conversion rate (purchases per notification), average delay between notification and purchase, and effectiveness of different message lengths or tones (data processing: aggregation, ratio calculation, correlation analysis). Based on these metrics, server updates configuration parameters used in prompt construction (e.g., whether to emphasize discounts or timing) and in generative AI model invocation (e.g., preferred maximum length, tone instructions) stored in a configuration table (output: updated configuration conditions for prompt sentences and proposal text generation).

### Step 17:

Server adapts machine-learned acquisition patterns and personalization.

Server applies a machine learning method to the history and interaction data (input: feature vectors representing schedule attributes, prices, message characteristics, and user responses).

Server trains or updates a model that predicts user likelihood to act under various conditions (data processing: feature normalization, model training using a loss function such as cross-entropy or mean squared error, weight updates by gradient descent). Server uses the trained model to derive user-specific acquisition patterns and preference parameters, then writes these as attributes into user and schedule records (output: personalized parameters guiding future prompt sentences and notification strategies).

### Step 18:

Server refines prompt sentences using updated patterns and configuration.

Server reads updated configuration and user-specific preference parameters from storage (input: per-user tone preference, length preference, sensitivity to discounts, timing sensitivity). Server adjusts prompt templates by inserting new instructions, such as “use a casual tone,” “limit to one sentence,” or “emphasize cost savings,” and recalculates which fields to include from schedule and evaluation index data (data processing: template editing, conditional inclusion of fields). Server outputs refined prompt sentences for subsequent calls to the generative AI model (output: next-generation prompt sentences better aligned with user behavior and system performance goals).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented purchase reminder systems rely on static rules and simple date arithmetic to determine reminder timing for periodically purchased items. Such systems typically treat purchase intervals as fixed, user-specified values and perform only basic retrieval of historical orders and unit prices. As a result, existing systems suffer from several technical shortcomings in the way information is processed and delivered by the computer itself.

First, conventional systems do not effectively exploit rich transaction record data available across multiple commerce applications. Purchase dates, quantities, and delivery conditions are often stored in heterogeneous formats in separate backend systems, and existing reminder engines largely ignore this time-series structure. Consequently, the processor performs inefficient, ad hoc queries and cannot maintain normalized statistical information, leading to redundant computations, increased database access load, and suboptimal scheduling of reminder tasks.

Second, conventional systems do not integrate statistical processing and machine learning with dynamic scheduling in a unified architecture. Where learning is used at all, it is often implemented as an offline batch analysis that is not tightly coupled to the reminder engine.

This separation results in duplicated data pipelines, inconsistent models of user behavior, and stale or inaccurate reminder times. The processor must repeatedly re-calculate intervals without maintaining an internal representation that can adapt to irregular patterns or seasonal variations, thereby degrading the technical performance of the scheduling subsystem.

Third, conventional systems perform price comparison in an isolated manner, without coordinating the comparison results with the learned purchase pattern and the reminder schedule. Existing implementations often compute lowest prices at the moment of user interaction only, or they treat external price-related data as single-shot inputs. Because the processor does not maintain integrated structures linking statistical usage information with multi-source price-related data, the system cannot efficiently compute optimal acquisition options that satisfy both timing constraints and cost constraints. This leads to inefficient use of network resources, redundant API calls, and increased computational overhead.

Fourth, the handling of natural language interactions in traditional systems is technically limited. In many implementations, free-form user messages for configuration changes cannot be robustly parsed, and the system requires rigid command formats or separate configuration screens. Even when generative models are used, they are often invoked only to display marketing messages, without any structured integration between the natural language analysis and the system's internal data structures. Thus, the processor cannot reliably map natural language configuration requests into normalized periodic acquisition target information and schedule information, which restricts automation and increases manual intervention.

Fifth, conventional systems that use generative models generally do not define a structured, prompt-based interface between the internal scheduling and pricing logic and the model. Prompt construction is often ad hoc and unstructured, leading to unpredictable outputs, difficulty in parsing results, and errors when attempting to update databases or schedules. This lack of a systematic prompt-sentence layer prevents the system from fully leveraging generative models as programmable components in the information processing pipeline. Accordingly, there is a need for an improved computer-implemented system in which a processor: (i) normalizes and relates user identification information and transaction identification information across communication and commerce applications; (ii) maintains statistical information and schedule information derived from transaction record data; (iii) integrates multi-source price-related data with the statistical model to compute optimal acquisition options subject to temporal constraints; and (iv) systematically uses a generative AI model via structured prompt sentences, both to generate proposal texts for users and to interpret natural language configuration change requests. Such a system should improve the efficiency, accuracy, and adaptability of the reminder computation process, reduce redundant data processing, and enable the computer to manage periodic acquisition of goods and services in a more automated and technically robust manner.

The specific processing by the specific processing unit 290 of the data processing device 12 in Application Example 1 is realized by the following means.

The present invention provides a server comprising a processor and a storage device, the processor being configured to execute instructions to: acquire user identification information via a communication application executed on an information processing apparatus, acquire transaction identification information via a commerce application executed on an information processing apparatus, associate the user identification information with the transaction identification information, and register associated identification information in the storage device; receive, via a user interface including a display device and an input device, identification information of goods or services repeatedly acquired by a user and information regarding an acquisition interval, and store the received information as periodic acquisition target information in the storage device; acquire transaction record data corresponding to the user via the commerce application, apply a statistical processing algorithm to acquisition time information and acquisition quantity information included in the transaction record data to calculate, for each good or service, a representative value of an acquisition interval and a variation index, and store resulting statistical information in the storage device; calculate, on the basis of the statistical information and the periodic acquisition target information, a next scheduled acquisition time for each good or service, generate a notification schedule time by applying a predetermined lead time to the next scheduled acquisition time, and register schedule information including the notification schedule time in the storage device; acquire price-related data for each good or service included in the periodic acquisition target information from a plurality of commerce applications, calculate a total payment amount for each piece of the price-related data based on sales price information and delivery condition information, select at least one candidate that satisfies a predetermined condition regarding the total payment amount by using a comparison processing algorithm, and store the selected candidate as an optimal acquisition option in the storage device; generate structured data including proposal content based on the next scheduled acquisition time and the optimal acquisition option, generate a prompt sentence for inputting the structured data to a generative information processing model configured to generate explanatory text, and transmit the prompt sentence to the generative information processing model; receive, from the generative information processing model, a proposal text expressed in a natural language, generate a notification message by adding reference information of a transaction screen of the commerce application to the proposal text, and transmit the notification message to a user terminal via the communication application; update the statistical information and the schedule information on the basis of new transaction record data received from the commerce application after transmission of the notification message, and recalculate subsequent next scheduled acquisition times and notification schedule times; and acquire, via the communication application, a configuration change request message expressed in a natural language and transmitted by the user, generate and transmit to the generative information processing model a prompt sentence for obtaining structured data representing an intent, a target good or service, and a change of the acquisition interval from the configuration change request message, receive an analysis result from the generative information processing model, and update the periodic acquisition target information and the schedule information on the basis of the analysis result. This enables the server to improve the technical functioning of the computer-implemented reminder system by maintaining normalized linkages between communication and commerce identifiers, by computing and updating statistically grounded and machine-learned acquisition schedules integrated with multi-source price-related data, and by using structured prompt sentences to tightly couple a generative AI model with internal data structures so that natural language proposal generation and configuration changes can be executed accurately and efficiently within the system.

The term “system” refers to a combination of at least one processing unit and at least one storage unit, together with executable instructions, communication interfaces, and external applications, that cooperatively perform the claimed functions.

The term “processor” refers to a hardware execution unit, such as a central processing unit or a processing core, configured to execute instructions that implement the information processing operations described in the claims.

The term “storage device” refers to any non-transitory computer-readable medium, including volatile or non-volatile memory, that is configured to store programs, identifiers, transaction records, statistical information, schedule information, and other data used by the processor.

The term “information processing apparatus” refers to any computing device, such as a server, a client device, or a terminal, that executes software to perform communication, commerce, or user interface functions.

The term “communication application” refers to a program executed on an information processing apparatus that provides a messaging or communication function enabling exchange of messages between the user and the system via a communication network. The term “commerce application” refers to a program executed on an information processing apparatus that provides electronic transaction functions for goods or services, including order placement, payment processing, and transaction record management.

The term “user identification information” refers to any data that uniquely or quasi-uniquely identifies a user within the communication application or within the system, such as an account identifier, user ID, or token.

The term “transaction identification information” refers to any data that uniquely or quasi-uniquely identifies a user or transactions within the commerce application, such as a customer identifier, account identifier, or transaction ID.

The term “associated identification information” refers to data that represents a linkage between user identification information and transaction identification information so that activities in the communication application and the commerce application can be correlated.

The term “user interface” refers to a combination of hardware and software elements, including at least a display device and an input device, through which the user can view information and provide input to the system.

The term “display device” refers to any output device, such as a screen or monitor, that visually presents information to the user.

The term “input device” refers to any hardware component, such as a touch panel, keyboard, pointing device, or microphone, that allows the user to input commands or data into the system.

The term “goods or services” refers to any items, products, digital content, or service offerings that can be acquired, ordered, or subscribed to via the commerce application.

The term “acquisition interval” refers to a time-related parameter that indicates a period between successive acquisitions of a particular good or service by the user.

The term “periodic acquisition target information” refers to data stored in the storage device that specifies goods or services repeatedly acquired by the user and parameters associated with such acquisitions, including at least identification information and an acquisition interval.

The term “transaction record data” refers to data representing past transactions of the user performed via the commerce application, including at least acquisition time information, acquisition quantity information, and optional pricing and delivery information.

The term “acquisition time information” refers to data indicating a timestamp or date-time at which a particular good or service was acquired in a transaction.

The term “acquisition quantity information” refers to data indicating the quantity or amount of a particular good or service acquired in a transaction.

The term “statistical processing algorithm” refers to a set of computer-executable procedures that perform numerical analysis on transaction record data, including calculating representative values, variation indices, and other statistical measures.

The term “representative value of an acquisition interval” refers to a statistical measure, such as a mean, median, or other central tendency, that characterizes a typical time interval between acquisitions of a particular good or service.

The term “variation index” refers to a statistical measure, such as a variance, standard deviation, or dispersion metric, that characterizes variability in the acquisition interval or quantity.

The term “statistical information” refers to data stored in the storage device that includes, for each good or service, one or more representative values of acquisition intervals, variation indices, and other derived statistical measures obtained from transaction record data.

The term “next scheduled acquisition time” refers to a time value calculated by the processor that indicates when the system expects or recommends the next acquisition of a particular good or service based on statistical information and periodic acquisition target information.

The term “notification schedule time” refers to a time value calculated by the processor that indicates when the system will generate and transmit a reminder or notification to the user prior to the next scheduled acquisition time.

The term “schedule information” refers to data stored in the storage device that includes at least next scheduled acquisition times and notification schedule times for one or more goods or services.

The term “price-related data” refers to data obtained from one or more commerce applications that includes at least sales price information, delivery condition information, and optionally tax, discount, or availability information for a good or service.

The term “sales price information” refers to data indicating a unit price or total price for a good or service offered via a commerce application.

The term “delivery condition information” refers to data indicating conditions associated with the delivery of goods or services, such as shipping cost, delivery time, shipping method, or geographic restrictions.

The term “total payment amount” refers to a value calculated by the processor that represents a combined cost to the user for acquiring a particular good or service, the combined cost being derived from at least sales price information and delivery condition information.

The term “comparison processing algorithm” refers to a set of computer-executable procedures that compare multiple pieces of price-related data or total payment amounts according to predetermined criteria to select one or more candidates.

The term “optimal acquisition option” refers to a candidate offer for acquiring a good or service that satisfies one or more predetermined conditions, such as minimal total payment amount or acceptable delivery conditions, as determined by the comparison processing algorithm.

The term “structured data” refers to data arranged in a predefined format, such as a key-value structure, list, or object representation, that encodes proposal content, schedule parameters, and other attributes in a machine-readable manner.

The term “proposal content” refers to information generated by the processor that summarizes recommended acquisition timing, selected offers, and related contextual information intended to be communicated to the user.

The term “prompt sentence” refers to a natural-language or semi-structured text sequence generated by the processor, which encodes structured data and instructions to guide a generative information processing model to produce a desired output.

The term “generative information processing model” refers to a software-implemented model, such as a generative AI model or language model, that receives a prompt sentence and outputs generated content, including at least explanatory text, proposal text, or interpreted structured information.

The term “explanatory text” refers to natural-language text generated by the generative information processing model that explains, describes, or recommends acquisition options or timing to the user.

The term “proposal text” refers to explanatory text produced by the generative information processing model in response to a prompt sentence that encodes proposal content.

The term “notification message” refers to a message generated by the processor that includes at least a portion of the proposal text and reference information to a transaction screen, and that is transmitted to a user terminal via the communication application.

The term “transaction screen” refers to a user interface screen provided by the commerce application that enables viewing, selection, and confirmation of a transaction for a good or service.

The term “user terminal” refers to an information processing apparatus used by the user, such as a smartphone, tablet, or personal computer, that executes at least the communication application and interacts with the system.

The term “configuration change request message” refers to a message expressed in a natural language by the user via the communication application, indicating a request to modify periodic acquisition target information or schedule information.

The term “intent” refers to a semantic representation of the user's purpose or requested operation contained in a configuration change request message, such as updating an acquisition interval, adding a new good or service, or canceling a periodic acquisition.

The term “target good or service” refers to a specific good or service to which a configuration change request message or periodic acquisition target information pertains.

The term “change of the acquisition interval” refers to a modification in a time-related parameter that defines how frequently a particular good or service should be acquired, as requested by the user.

The term “analysis result” refers to structured data or interpretation output generated by the generative information processing model in response to a prompt sentence, the structured data indicating at least an intent, a target good or service, and a change of the acquisition interval.

In one embodiment, a server implements the claimed system by executing instructions on a hardware platform including at least one multi-core central processing unit, a main memory, a non-volatile storage device, and a network interface. The server runs an operating system such as a UNIX-like system and application software such as a web application framework (for example, a framework comparable to a common server-side scripting framework) and a database management system such as a relational database engine. The server communicates with a terminal operated by a user over a packet-based network. The terminal is, for example, a smartphone, tablet, or personal computer executing a communication application and a web browser or native commerce application. The user operates the terminal via a touch screen or other input device.

The server executes a communication application integration module that communicates with an external messaging platform via a messaging application programming interface. The server also executes a commerce application integration module that communicates with one or more external commerce platforms via commerce application programming interfaces. The server further executes a data management module, a statistical analysis module, a scheduling and recommendation module, and a generative AI integration module.

The server uses the communication application integration module to acquire user identification information. The server receives, via a secure network protocol, authentication tokens or user identifiers transmitted from the communication application running on the terminal. The server parses the protocol messages to extract user identification information, such as an application-specific user ID, and stores the information in tables of the relational database. The server uses the commerce application integration module to acquire transaction identification information for the same user from a commerce application. The server receives, for example via an authorization flow, a commerce customer identifier that uniquely identifies the user within the commerce platform. The server associates the user identification information and the transaction identification information by storing them as linked records in an association table of the database, thereby enabling the server to correlate messages received through the communication application with transaction records obtained from the commerce application.

The server causes the terminal to display a user interface that allows the user to specify goods or services that are repeatedly acquired and to specify an acquisition interval. The terminal executes display processing and shows form elements, buttons, and selection lists. The user inputs identification information of goods or services, such as item names or catalog identifiers, and selects intervals, such as a number of days or a natural language period like “every month.” The terminal transmits the input data as structured messages to the server.

The server receives the data and registers the data in the database as periodic acquisition target information. The server stores, for each user and each good or service, fields including a product identifier, a nominal acquisition interval, a start date, and an activity flag. The server may obtain additional attributes of the goods or services from the commerce application, such as descriptions, stock-keeping unit codes, and base prices, and cache these attributes in product tables.

The server acquires transaction record data for each user via the commerce application integration module. The server calls commerce platform interfaces to retrieve past orders associated with the transaction identification information. The returned data comprise order headers and line items that include acquisition time information, acquisition quantity information, and price and delivery data. The server normalizes the received data into internal data structures and persists them in order tables in the database. The server then invokes the statistical analysis module to apply a statistical processing algorithm over the acquisition time information and acquisition quantity information.

The statistical processing algorithm executed by the server includes operations such as sorting transaction events by timestamp, calculating inter-purchase intervals as differences between successive timestamps for the same item, and computing representative values such as arithmetic means or medians of the intervals. The server also calculates variation indices such as standard deviation and coefficient of variation for each item. To perform these computations, the server uses vectorized numeric routines implemented in a numerical library, which operate on arrays of timestamps and quantities. The server stores, for each user and each good or service, calculated representative values of the acquisition interval, variation indices, and last acquisition timestamps in statistical information tables. By maintaining these pre-computed statistical features, the server reduces repeated scanning of full order histories and improves computation efficiency for subsequent scheduling.

The server generates, on the basis of the statistical information and the periodic acquisition target information, next scheduled acquisition times. The server combines user-configured intervals with learned representative intervals by applying rule sets. For example, the server may use the user-configured interval when variation is low and may adjust the interval using the learned representative value when variation exceeds a threshold. The server uses date arithmetic functions to add the selected interval to the last acquisition timestamp or to the start date. The server then generates notification schedule times by subtracting a predetermined lead time (for example, several days) from the next scheduled acquisition times. The server stores both next scheduled acquisition times and notification schedule times in schedule information tables. This explicit schedule representation allows the server to perform indexed queries for upcoming notifications, thereby reducing computational cost compared to recomputing schedules on each request.

The server acquires price-related data from multiple commerce applications for goods or services included in the periodic acquisition target information. The commerce application integration module transmits requests containing product identifiers or search terms to external interfaces and receives responses that include sales price information, delivery condition information, and availability indicators. The server parses the responses and builds a set of candidate offers for each item. For each candidate, the server computes a total payment amount by summing sale price and shipping cost and by optionally adjusting for taxes or discounts. The server applies a comparison processing algorithm that filters out candidates with unacceptable delivery times or other constraints and ranks remaining candidates by total payment amount and additional criteria. The server stores the top-ranked candidate as an optimal acquisition option in a recommendation table. Because the server performs these computations in batch form and stores results, the server avoids redundant remote requests, decreases latency, and improves network resource utilization.

The server uses a generative AI integration module to interact with a generative AI model. In one embodiment, the generative AI model is a transformer-based neural network composed of multiple self-attention layers, feed-forward layers, and normalization layers, pre-trained on a large corpus of text and optionally fine-tuned on domain-specific messages. The model accepts text tokens as input and outputs text tokens in an auto-regressive manner. The server does not treat the model as a black box; rather, the server supplies structured prompt sentences that encode specific features and constraints, and the server constrains decoding parameters such as temperature and maximum token length to achieve stable and parseable outputs.

For proposal generation, the server constructs structured data including, for each user and item, the next scheduled acquisition time, the optimal acquisition option, and selected statistical features such as average interval and variance. The server then generates a prompt sentence by embedding these values into a natural language instruction. For example, the server may create a prompt sentence such as:

“Create a concise reminder message for a user about an upcoming purchase. Product: ‘toilet paper multi-roll pack’. Next scheduled acquisition date: 2024 Apr. 23. Best offer: 15 currency units including shipping from a selected seller. Explain briefly why this timing and offer are recommended, and include a call-to-action phrase suitable for a mobile messenger notification.”

The server transmits this prompt sentence to the generative AI model via a network interface. The generative AI model processes the tokenized prompt through its attention layers, computing weighted combinations of token embeddings that capture time, price, and product context. The model outputs a sequence of tokens that form a proposal text in natural language. The server receives the token sequence, decodes it into text, and may post-process it to enforce constraints such as maximum length and absence of undesired tokens. The server then constructs a notification message that combines the proposal text with a reference to a transaction screen, such as a URL for a pre-configured shopping cart. The server transmits the notification message to the terminal via the communication application integration module. The terminal receives the message and, under control of its operating system, displays a notification banner or opens the communication application UI. The user can tap a link in the message, and the terminal opens a browser or commerce application to the indicated transaction screen.

The server further uses the generative AI model to interpret configuration change request messages expressed in natural language. When the user types a message such as “Change my toilet paper schedule to every 6 weeks” in the communication application on the terminal, the terminal transmits the message content to the server. The server generates a prompt sentence that instructs the generative AI model to output a structured interpretation. For example, the server may create a prompt sentence such as:

“You are an intent parsing assistant for a purchase reminder system. Interpret the following user message and output a JSON-like object with fields: action (update_interval or cancel_product), product_name, interval_days (integer or null). Message: ‘Change my toilet paper schedule to every 6 weeks.’”

The generative AI model processes this prompt, uses its internal attention to map tokens such as “change”, “toilet paper”, and “every 6 weeks” to semantic roles, and generates a short text representing an action code, a product name, and an interval in days. The server parses this generated text and extracts a symbolic representation of the intent, the target good or service, and the requested change of the acquisition interval. The server then updates the periodic acquisition target information and schedule information in the database accordingly and recalculates the next scheduled acquisition times. By using the generative AI model in this tightly constrained, feature-oriented manner, the server reduces ambiguity compared to humans manually interpreting free text and improves robustness relative to conventional rule-based parsers.

The generative AI model is trained using supervised learning. During pre-training, a large set of text sequences is provided, and the model parameters, including weight matrices in attention and feed-forward layers, are updated to minimize a cross-entropy loss between predicted tokens and actual tokens. During fine-tuning for this application, example pairs of prompt sentences and desired outputs (such as recommended date explanations or parsed configuration commands) are used. The server or an offline training platform uses backpropagation to compute gradients of the loss with respect to weights and applies an optimization algorithm such as an adaptive learning rate method to update parameters. Data augmentation techniques, such as paraphrasing of configuration messages or variation in date and product descriptions, are used to improve generalization. As a result, the model learns specialized mappings from domain-specific prompt sentences to structured or semi-structured responses that are reliably parseable by the server.

The server also uses a machine learning algorithm distinct from the generative AI model to refine purchase timing. In one embodiment, the server constructs feature vectors for each acquisition event that include interval length, quantity consumed, seasonality markers (for example, month index, holiday flags), and user-specific attributes. The server trains a regression or sequence model, such as a recurrent neural network or a gradient boosted decision tree model, to predict the next consumption exhaustion date. The loss function penalizes deviations between predicted and actual replenishment times. The server applies the learned model to generate a correction value that adjusts the next scheduled acquisition time derived from the statistical processing algorithm. By combining rule-based and learned predictions, the server achieves higher timing precision than either approach alone and reduces early or late reminders, thereby decreasing unnecessary network traffic and user interactions.

The described architecture improves computer technology in multiple ways. By storing normalized statistical information and schedule information separately from raw transaction records, the server reduces the amount of data that must be scanned for each reminder computation and limits index range scans, improving processing speed. By precomputing and caching optimal acquisition options, the server minimizes repeated calls to external commerce APIs, which reduces network load and latency. The explicit data structures for association, periodic acquisition targets, statistical information, and schedule information enable efficient join and filter operations in the database and improve cache locality in the server's memory subsystem. The integration of the generative AI model via structured prompt sentences ensures that the model's outputs can be deterministically mapped back into structured actions and messages, reducing parsing errors and exception handling overhead. Because the generative AI model is used to transform structured internal data into optimized human-readable content and to interpret free-form user commands into structured updates, the system performs transformations that would be difficult to implement with fixed rules without significant complexity and fragility.

In contrast to manual human workflows where a person inspects transaction histories and composes reminders, the server executes algorithmic procedures that exploit statistical features, trained models, and prompt-based generative reasoning. The server applies non-conventional processing patterns, such as combining cross-application identifier mapping, time-series statistical computation, multi-source price optimization, and constrained generative AI inference in a single integrated pipeline. This non-traditional combination yields technical effects including reduced storage access, improved prediction accuracy of acquisition timing, reduced rate of unnecessary notifications, and lower overall network usage.

Alternative embodiments are possible within the same framework. In one variation, the terminal is a specialized appliance located in a physical environment such as a home or store, equipped with sensors that estimate consumption of goods (for example, weight sensors or optical sensors). The terminal periodically transmits sensor readings to the server. The server treats sensor-derived consumption estimates as additional features for the statistical and machine learning modules, refining predictions of depletion dates. This yields a tighter coupling between real-world physical measurements and the server's scheduling computations, further improving accuracy.

In another variation, the server deploys a different type of generative AI model, such as an encoder-decoder transformer, specifically fine-tuned for short-form messaging. The server may also use rule-based templates for high-risk or regulated items and use the generative AI model only for personalization fields. In yet another embodiment, the server dynamically adapts the prompt sentence based on observed variance of model output, adjusting the level of constraint or including explicit output format instructions when variance is high, thereby improving robustness.

In all these embodiments, the core technical feature is that the server controls the flow of data through well-defined internal data structures, statistical algorithms, machine learning models, and generative AI models connected via explicit prompt sentences. The terminal and the user interact with the system only through defined communication channels. The improved internal handling of identifiers, histories, statistics, schedules, prices, and natural language interactions allows the server to execute more efficient, accurate, and scalable reminder and recommendation operations than conventional systems, thereby providing a concrete improvement in the functioning of the computer-based reminder infrastructure.

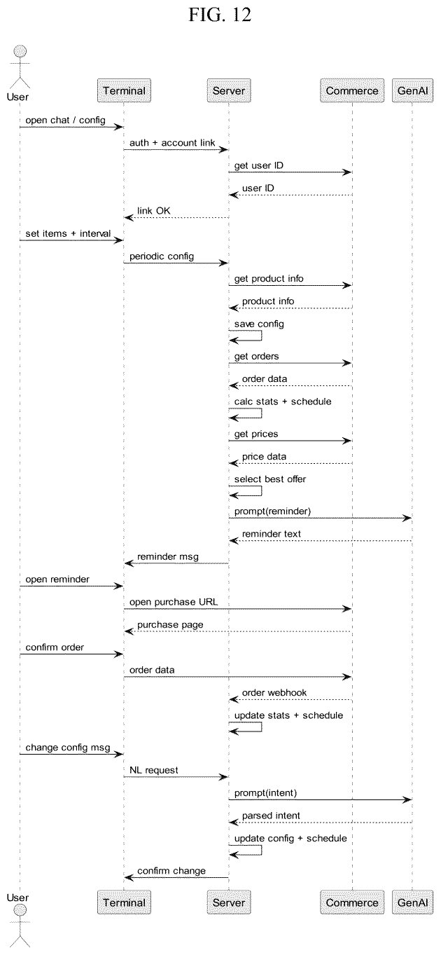

The following describes the processing flow using FIG. 12.

### Step 1:

Server acquires and links identification information.

Server receives, as input, authentication data transmitted from Terminal via a communication application and a commerce application. Server parses protocol messages to extract a communication-side user identifier and a commerce-side transaction identifier. Server performs data processing that includes validation of token signatures, normalization of identifier formats, and detection of existing records. Server writes, as output, an association record into a database table that stores a mapping between the communication-side user identifier and the commerce-side transaction identifier, and returns a confirmation status to Terminal.

### Step 2:

Terminal presents configuration interface and transmits periodic acquisition target information.

Terminal receives, as input, a request from Server to display a configuration screen and a list of candidate goods or services. Terminal renders UI elements such as item selection lists and interval selection controls. User selects one or more goods or services and specifies acquisition intervals and optional start dates. Terminal packages these user selections as structured configuration data and transmits, as output, the configuration data to Server via a secure network connection.

### Step 3:

Server registers periodic acquisition target information.

Server receives, as input, configuration data from Terminal that includes product identifiers, nominal acquisition intervals, and start dates for each selected good or service. Server validates the data by checking that product identifiers exist in product tables and that intervals are positive values. Server performs data processing that converts intervals into a normalized unit (for example, days) and calculates an initial next scheduled acquisition time as start date plus interval. Server stores, as output, periodic acquisition target records in a database table, including fields for user identifier, product identifier, interval, start date, and initial next scheduled acquisition time.

### Step 4:

Server acquires and normalizes transaction record data.

Server receives, as input, a user identifier and associated commerce-side transaction identifier from its association records. Server issues requests to external commerce application interfaces to retrieve past orders for the user. Server obtains, as input from the commerce application, transaction record data including timestamps, product identifiers, quantities, and prices. Server performs data processing that includes parsing response messages, converting timestamps to a common time zone and format, and mapping remote product codes to internal product identifiers. Server writes, as output, normalized transaction records into order tables in the database.

### Step 5:

Server computes statistical information for acquisition intervals.

Server retrieves, as input, transaction records per user and product from the order tables.

Server sorts acquisition events by timestamp and calculates inter-purchase intervals by subtracting consecutive timestamps. Server applies statistical processing, including computing arithmetic means, medians, and standard deviations of the inter-purchase intervals and determining last acquisition timestamps. Server stores, as output, statistical information records in dedicated tables, containing at least an average interval, a variation index, and the last acquisition date for each product and user.

### Step 6:

Server calculates next scheduled acquisition times and notification schedule times.

Server receives, as input, statistical information and periodic acquisition target information for each product and user. Server applies decision rules that select either the user-configured interval or a learned average interval, for example by comparing a variation index to a threshold. Server performs date arithmetic that adds the selected interval to the last acquisition timestamp or to the start date to obtain a next scheduled acquisition time. Server then subtracts a predetermined lead time from the next scheduled acquisition time to compute a notification schedule time. Server stores, as output, schedule information records that include next scheduled acquisition times and notification schedule times in a scheduling table.

### Step 7:

Server collects multi-source price-related data and determines optimal acquisition options.

Server receives, as input, product identifiers from periodic acquisition target records for which upcoming schedules exist. Server sends queries with these identifiers to multiple commerce application interfaces and receives, as input, price-related data including unit prices, shipping costs, and delivery conditions. Server performs data processing that computes total payment amounts by adding unit price and shipping cost and optionally adjusting for taxes or discounts. Server applies a comparison algorithm that filters offers by constraints such as maximum delivery time and ranks candidates by total payment amount.

Server stores, as output, for each product and user, at least one optimal acquisition option record containing a selected offer and its total payment amount.

### Step 8:

Server prepares structured proposal data.

Server retrieves, as input, schedule information, optimal acquisition option records, and statistical information for items whose notification schedule times are approaching. Server constructs, through data aggregation, structured proposal data for each user-product pair, including next scheduled acquisition time, selected offer details, average interval, and variation index. Server outputs these structured proposal data objects internally to the generative AI integration module as an input basis for prompt construction.

### Step 9:

Server generates a prompt sentence for proposal text.

Server receives, as input, the structured proposal data objects produced in Step 8. Server executes string formatting operations to embed fields such as product name, next scheduled acquisition date, and best offer price into a natural-language instruction template. Server, as an example, may generate a prompt sentence such as:

“Create a concise reminder message for a user about an upcoming purchase. Product: ‘toilet paper multi-roll pack’. Next scheduled acquisition date: 2024 Apr. 23. Best offer: 15 currency units including shipping from a recommended seller. Explain briefly why this timing and offer are recommended, and include a call-to-action phrase suitable for a mobile messenger notification.”

Server outputs, as output of this step, a complete prompt sentence string ready to be sent to the generative AI model.

### Step 10:

Server invokes the generative AI model to obtain proposal text.

Server receives, as input, a prompt sentence and model configuration parameters such as model name, temperature, and maximum token count. Server transmits the prompt sentence to a remote generative AI model endpoint via a network request. The generative AI model, implemented as a transformer neural network with multiple attention layers and trained with a cross-entropy loss function, processes the prompt and generates output tokens representing a proposal text. Server receives, as input from the model, the sequence of output tokens and decodes them into a natural-language proposal text string. Server outputs the proposal text for use in message composition.

### Step 11:

Server composes and transmits notification messages.

Server receives, as input, the proposal text from Step 10 and reference information for a transaction screen, such as a pre-configured purchase URL. Server performs text concatenation and formatting to embed the reference information into the proposal text, optionally inserting a call-to-action phrase. Server constructs a notification message object that includes the communication-side user identifier and the message body. Server transmits, as output, the notification message via the communication application integration module to the messaging platform, which delivers it to Terminal.

### Step 12:

Terminal displays notification and provides access to the transaction screen.

Terminal receives, as input, the notification message via the communication application. Terminal's operating system generates a user-visible notification and, when User interacts with it, opens the communication application conversation view. Terminal displays, as output, the message containing the proposal text and the embedded transaction screen reference. When User taps the reference, Terminal's browser or commerce application opens the specified transaction screen, using the received URL as input, and renders the corresponding page or purchase interface.

### Step 13:

User reviews and executes a purchase.

User receives, as input, the displayed proposal message and the transaction screen rendered on Terminal. User reviews product details, prices, and delivery conditions and may adjust quantities or options via the UI controls. User confirms the purchase by activating a purchase command such as a “buy” or “checkout” button. Terminal packages these confirmations as order data and transmits, as output, the order data to the commerce application.

### Step 14:

Server receives new transaction records and updates statistical and schedule information.

Server receives, as input, order notifications or webhooks from the commerce application, containing updated transaction record data such as order IDs, product identifiers, quantities, and timestamps. Server normalizes and stores these new records in the order tables, in the same manner as in Step 4. Server then re-invokes the statistical processing algorithm using the extended transaction history, recalculating representative intervals and variation indices.

Server outputs updated statistical information and recomputes next scheduled acquisition times and notification schedule times, updating schedule information records to reflect the new purchase.

### Step 15:

User sends configuration change request via natural language.

User provides, as input, a free-form message in the communication application on Terminal, such as “Change my toilet paper schedule to every 6 weeks” or “Stop reminders for coffee beans.” Terminal captures this text and transmits, as output, the message content and the communication-side user identifier to Server.

### Step 16:

Server constructs a prompt sentence for intent parsing.

Server receives, as input, the natural-language configuration change request message and the associated user identifier. Server constructs a structured prompt sentence that instructs the generative AI model to output a machine-interpretable representation. For example, Server may create a prompt sentence such as:

“You are an intent parsing assistant for a purchase reminder system. Interpret the following user message and output a JSON-like object with fields: action (update_interval or cancel_product), product_name, interval_days (integer or null). Message: ‘Change my toilet paper schedule to every 6 weeks.“ ”

Server outputs this prompt sentence for subsequent transmission to the generative AI model.

### Step 17:

Server invokes the generative AI model to obtain a structured interpretation.

Server receives, as input, the intent-parsing prompt sentence. Server transmits the prompt sentence to the generative AI model using the same or similar network interface as in Step 10. The generative AI model processes the tokens, identifying action verbs, product names, and temporal expressions, and generates a short text string that encodes an action type, target product name, and interval in days. Server receives, as input, this generated text and treats it as a raw interpretation output.

### Step 18:

Server parses interpretation and updates periodic acquisition target and schedule information.

Server receives, as input, the raw interpretation text from the generative AI model. Server applies a parsing routine that extracts an action code, a product label, and a numeric interval value if present. Server then queries its database to identify the corresponding product identifier for the extracted product label. If the action is an interval update, Server updates the interval field for the matching periodic acquisition target record and recalculates the next scheduled acquisition time and notification schedule time using the updated interval. If the action is a cancel request, Server sets an activity flag to an inactive state for that periodic acquisition target record and cancels associated schedule entries. Server stores, as output, updated periodic acquisition target records and schedule information records, and may generate a confirmation message to be sent to Terminal.

### Step 19:

Server sends configuration change confirmation.

Server receives, as input, the results of the update operations from Step 18, including new interval values or cancellation status. Server composes a confirmation message in simple natural language, such as “Your toilet paper reminder interval has been changed to every 6 weeks” or “Reminders for coffee beans have been stopped.” Server includes the communication-side user identifier and the message body in a message object. Server transmits, as output, the confirmation message via the communication application integration module to Terminal, thereby closing the configuration change cycle.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented purchase support systems typically perform simple rule-based reminders or static calendar scheduling based on manually specified cycles. Such systems suffer from several technical limitations. First, server-side processing often treats heterogeneous transaction logs from different service interfaces and commerce interfaces as independent data sources, which leads to redundant storage formats, inconsistent time axes, and inefficient query plans. As a result, prediction logic must repeatedly perform ad hoc transformations at run time, increasing processor load and network latency, and making it difficult to scale to large numbers of users and items.

Second, existing systems usually implement purchase timing estimation with fixed statistical rules or coarse-grained heuristics, without tightly integrating a machine learning model that is trained on normalized, time-aligned transaction sequences. This causes the processor to rely on simplistic interval computations that do not adapt as user behavior changes, reducing the accuracy of next-purchase predictions and forcing frequent manual overrides by the user. From a computing perspective, resources are consumed on repeated inaccurate reminders and unnecessary network transmissions between a server and user terminals.

Third, many systems separate predictive computation from user-facing message generation. Predictive engines produce low-level numerical outputs (for example, dates or scores), while a separate application layer or human operator must craft user notifications. This decoupling results in repeated, non-structured conversions of prediction outputs into natural-language text, often implemented as hard-coded templates. This increases code complexity, reduces maintainability, and prevents the system from flexibly adapting message content to different contexts, levels of detail, or communication interfaces.

Fourth, when user feedback (for example, “remind me later,” “this reminder was early,” or “skip this purchase”) is received at the terminal, typical systems either discard such feedback or log it separately without integrating it back into the predictive pipeline. Consequently, the machine learning model and the preprocessing pipeline are not updated in a systematic way, leading to a static model that does not improve over time and continues to produce suboptimal predictions. This wastes computational resources because the same inaccurate model is repeatedly executed on the server.

Fifth, when integrating a generative artificial intelligence model to create natural-language notifications, conventional approaches often send raw or loosely structured prediction data in arbitrary formats. The absence of a standardized, programmatically generated prompt and structured internal data causes inconsistent outputs, difficulty in controlling explanation detail, and unnecessary token usage. This degrades the efficiency of calls to the generative model, increases inference latency, and makes it hard to guarantee deterministic behavior suitable for large-scale deployment.

Accordingly, there is a need for a computer-implemented technique in which a processor of a server (i) unifies identification information between a communication function and a transaction function, (ii) normalizes and time-aligns transaction history into learning data, (iii) trains and applies a time-series machine learning model to compute accurate prediction information regarding next acquisition intervals, (iv) computes recommendation information by combining predicted timing with multi-source price and condition data, (v) constructs structured internal data and dynamically generated prompt sentences for a generative AI model, and (vi) incorporates user feedback for continual model retraining. Such a technique would improve the operation of the computer system itself by reducing redundant preprocessing, improving prediction accuracy, enabling scalable and controllable natural-language message generation, and reducing unnecessary network and computation overhead.

The specific processing by the specific processing unit 290 of the data processing device 12 in Example 2 is realized by the following means.

The present invention provides a server comprising a processor and a storage device, the processor being configured to associate identification information of a communication function and a transaction function by acquiring user identification information and authentication information, performing authentication based on the authentication information, and storing associated identification information in the storage device; to receive, via a user interface, input information including attribute information of acquisition targets repeatedly acquired by a user and information concerning acquisition cycles of the acquisition targets, normalize the input information, and store the normalized input information as target management information in the storage device; to collect transaction history information from one or more external transaction services, perform preprocessing including missing-value completion and conversion of timestamps to a unified time axis, and store the preprocessed transaction history information as learning data in the storage device; to execute a learning process using the learning data as input to train a time-series machine learning model, and to generate prediction information by causing the machine learning model to output, for each acquisition target, a time interval until a next acquisition; to acquire price information and associated condition information from a plurality of transaction services, compute an effective price index for each candidate based on the price information and the associated condition information, and determine recommendation information including a recommended acquisition time and recommended acquisition conditions for each acquisition target based on the prediction information and user setting conditions; to generate structured internal data by combining the prediction information and the recommendation information, and dynamically create a prompt sentence for a generative AI model by embedding the internal data into an instruction sentence that specifies notification targets, explanation detail level, writing style, and length constraints; to input the prompt sentence and the internal data into the generative AI model, obtain a generated explanatory sentence or proposal sentence from the generative AI model, and transmit the generated sentence to a user terminal via the communication function; and to generate relearning data based on response information received from the user terminal, update the learning data, and execute a relearning process on the machine learning model using the relearning data so as to improve accuracy of the prediction information. This enables improvement of the operation of the computer system by standardizing data representation across heterogeneous communication and transaction services, reducing redundant runtime preprocessing, increasing accuracy and stability of purchase timing predictions, automatically generating context-appropriate natural-language notifications under controllable constraints via the generative AI model, and continuously adapting the machine learning model to user behavior through integrated feedback-driven retraining.

The term “system” refers to an arrangement of one or more computing devices including at least one processor and one or more storage devices, configured to execute programmed instructions to perform the operations described herein.

The term “processor” refers to a hardware processing unit, such as a central processing unit or graphics processing unit, or a combination thereof, that executes machine-readable instructions to perform arithmetic, logical, control, and input/output operations.

The term “storage device” refers to any non-transitory computer-readable medium, including volatile or non-volatile memory, that stores data, models, configuration information, and program instructions for access by the processor.

The term “communication function” refers to a software or hardware communication interface, such as a messaging interface, network communication module, or application programming interface, that enables sending and receiving information between the system and external devices or services.

The term “transaction function” refers to a software or hardware interface, such as an electronic commerce interface or order management interface, that enables acquisition, management, or processing of transaction-related information including orders, prices, and product data.

The term “identification information” refers to data that uniquely or quasi-uniquely identifies a user, device, account, service interface, or combination thereof, such as user IDs, account IDs, or tokens, which is used to associate the communication function and the transaction function.

The term “authentication information” refers to data used to verify the identity or access rights of a user or system component, including credentials such as passwords, cryptographic tokens, or authorization codes.

The term “user interface” refers to a software or hardware mechanism, such as a graphical user interface, web interface, or application interface, through which a user can input information and receive information from the system.

The term “acquisition target” refers to a product, service, or other object of a transaction that is repeatedly obtained, purchased, or subscribed to by a user.

The term “attribute information” refers to descriptive data relating to an acquisition target, including but not limited to a name, category, identifier, quantity, brand, size, or other characteristic.

The term “acquisition cycle” refers to a time interval, schedule, or periodic pattern associated with repeated acquisition of an acquisition target by a user.

The term “target management information” refers to data structures stored in the storage device that represent normalized information about acquisition targets and associated acquisition cycles for use in prediction and recommendation processing.

The term “transaction history information” refers to records of past transactions, such as orders or purchases, including data such as dates, items, quantities, prices, and status, obtained from one or more external transaction services.

The term “external transaction service” refers to any remote system or service, such as an electronic marketplace or payment platform, that provides transaction history information or price information via a network interface.

The term “missing-value completion” refers to a preprocessing operation in which absent, null, or incomplete elements in transaction history information are inferred, imputed, or filled based on rules, default values, or statistical methods.

The term “conversion of timestamps to a unified time axis” refers to a preprocessing operation in which time-related data from different sources or time zones is normalized into a common temporal representation, such as a unified time zone or standardized time format, to enable consistent time-series analysis.

The term “learning data” refers to preprocessed and structured data derived from transaction history information and related attributes, which is used as input for training or retraining a machine learning model.

The term “time-series machine learning model” refers to a machine learning model configured to process sequences of data ordered in time, such as recurrent models or sequence models, in order to learn temporal patterns and make time-based predictions.

The term “prediction information” refers to output data generated by the time-series machine learning model, including at least an estimated time interval until a next acquisition for each acquisition target, and optionally including associated confidence measures or auxiliary prediction metrics.

The term “price information” refers to data regarding monetary amounts associated with acquisition targets, including unit prices, total prices, discounts, shipping costs, or other price-related parameters obtained from transaction services.

The term “condition information” refers to ancillary data associated with price information, including factors such as seller rating, delivery time, availability, return policy, or other conditions relevant to a transaction.

The term “effective price index” refers to a computed metric that combines price information and condition information for each candidate offer, in order to evaluate or rank the relative economic efficiency or desirability of the candidate.

The term “user setting conditions” refers to configuration data specified by the user, such as notification timing preferences, price thresholds, acceptable sellers, or other constraints, which influence the determination of recommendation information.

The term “recommendation information” refers to data generated by the processor that specifies, for each acquisition target, at least a recommended acquisition time and recommended acquisition conditions, such as a selected offer or seller, based on prediction information and user setting conditions.

The term “structured internal data” refers to data organized in a defined schema or data structure, such as a record, table, or serialized format, that combines prediction information and recommendation information for use in further processing.

The term “prompt sentence” refers to a machine-readable instruction text, optionally including embedded structured internal data, that is supplied as input to a generative AI model to control or guide generation of natural-language output.

The term “instruction sentence” refers to a portion of the prompt sentence that specifies requirements for generated output, including notification targets, explanation detail level, writing style, and length constraints.

The term “generative AI model” refers to a generative information processing model, such as a language model or text generation model, configured to produce natural-language text or other content based on input prompts and, optionally, structured data.

The term “explanatory sentence” refers to natural-language text generated by the generative AI model that explains prediction information, recommendation information, or system behavior to a user.

The term “proposal sentence” refers to natural-language text generated by the generative AI model that suggests specific actions, such as purchase recommendations or scheduling suggestions, to a user.

The term “user terminal” refers to an end-user device, such as a smartphone, computer, or tablet, equipped with a communication capability and a user interface for sending input to and receiving output from the server.

The term “response information” refers to data transmitted from the user terminal to the server that reflects user actions or feedback, such as acceptance, postponement, rejection of recommendations, or purchase confirmations.

The term “relearning data” refers to updated or augmented learning data derived from transaction history information and response information, which is used to retrain or fine-tune the time-series machine learning model.

The term “relearning process” refers to a training or fine-tuning operation performed by the processor on the time-series machine learning model using relearning data, in order to improve the accuracy or robustness of prediction information.

The term “notification targets” refers to one or more acquisition targets, user segments, or events selected by the system as subjects for which notifications or messages are to be generated and delivered.

The term “explanation detail level” refers to a setting or parameter indicating how much descriptive or analytical information is to be included in generated explanatory sentences or proposal sentences.

The term “writing style” refers to characteristics of generated natural-language text, such as tone, formality, or phrasing, that are specified in the instruction sentence and implemented by the generative AI model.

The term “length constraints” refers to one or more limitations on the size of generated output, such as maximum word count, character count, or number of sentences, specified in the instruction sentence for the generative AI model.

In one embodiment, a server implements the claimed system on a computing platform that includes at least one processor, a main memory, a non-transitory storage device, and one or more network interfaces. The server executes an operating system such as a general-purpose server operating system and runs application software implemented, for example, in a high-level programming language. The server uses a database management system such as a relational database to store user-related records, transaction history, learned model parameters, and generated prediction information. The server communicates with at least one terminal operated by a user, and with one or more external transaction services and communication services, via a packet-based network.

The server associates identification information of a communication function and a transaction function by maintaining specific data structures in the database. The server stores, in a first table, communication-account records including fields such as an internal user identifier, a communication-service identifier, and an authentication token. The server stores, in a second table, transaction-account records including an internal user identifier, a transaction-service identifier, and an access token or equivalent authorization credential. The server generates a third record structure that associates the communication-account record and the transaction-account record through the internal user identifier. The server thereby creates consistent identification information that uniquely associates a user's communication endpoint and a user's transaction endpoint within the system.

The server receives, from the terminal, input information including attribute information of acquisition targets and acquisition cycles. The terminal presents a user interface such as a web page or a native application view that enables the user to enter, for example, a product name, category, quantity, and a desired acquisition cycle expressed as a number of days or weeks. The server applies a normalization procedure to the input information, which includes converting text to a standard case, removing extraneous characters, mapping free-form text to standardized categories using a lookup table, and optionally resolving acquisition targets to canonical product identifiers via a search function in an external transaction service. The server then stores the normalized data as target management information in a dedicated table, including fields for the internal user identifier, normalized target name, standardized product identifier, and normalized acquisition cycle. Because the acquisition targets and cycles are stored in a unified, normalized schema, the server can perform efficient bulk queries and avoid repeated ad hoc parsing at run time, thereby improving data management and query speed.

The server collects transaction history information from external transaction services that expose application programming interfaces. The server uses stored access tokens to authenticate to these services and obtains transaction history in a structured format such as a serialized object or message. The server parses the received records and stores them into a raw transaction table with fields including a transaction identifier, user identifier, acquisition target identifier, timestamp, quantity, unit price, total price, and additional condition information such as shipping cost and service provider rating. The server then performs missing-value completion by applying predetermined rules, for example, inferring a quantity of one if quantity is missing and the service guarantees single-item orders, or omitting records that lack a valid timestamp. The server converts all timestamps to a unified time axis, such as coordinated universal time, and stores the normalized timestamps in a separate column for time-series processing.

The server constructs learning data by aggregating and transforming the normalized transaction history into a time-series representation suitable for a machine learning model.

The server computes, for each user and each acquisition target, a sequence of inter-acquisition intervals by calculating the difference in days between consecutive normalized timestamps. The server also constructs additional feature vectors that may include, for each transaction, the day of week, month of year, season indicator, normalized quantity, normalized unit price, and flags representing promotions or special conditions. The server encodes categorical identifiers such as acquisition target identifiers as integer indices and stores mapping tables between identifiers and indices. The server groups these sequences into fixed-length segments, for example, segments of N past transactions, and pads or truncates them as needed. These segments are stored as learning data, which the server writes either into structured database tables or into array files accessible by a machine learning library.

The server trains a time-series machine learning model using the learning data. In one example embodiment, the server implements a recurrent neural network architecture such as a long short-term memory network using a machine learning library. The server defines an embedding layer to transform acquisition target indices into dense vectors, one or more recurrent layers that process the temporal sequence of features, and a fully connected output layer that outputs a scalar representing the predicted inter-acquisition interval in days. The server initializes model parameters using a random initialization method and defines a loss function such as mean squared error between the predicted interval and the actual interval observed in the training data. The server uses an optimization algorithm such as a gradient-based optimizer with a predefined learning rate to update model weights.

The server executes a learning loop where, for each batch of training samples, the server performs a forward pass through the network to compute predicted intervals, evaluates the loss function, computes gradients via backpropagation through time, and updates the model weights according to the optimization algorithm. The server monitors the loss on a validation subset of the data and applies early stopping or learning rate scheduling if the validation loss ceases to improve. The server thereby produces a trained time-series machine learning model that is specialized to predict the time interval until the next acquisition for given features and acquisition targets.

The server stores the trained model parameters, together with metadata describing the training data distribution, feature definitions, and model version, in the storage device. Because the server uses a unified time-axis representation and standardized feature extraction, the same model can be applied consistently across transaction history originating from multiple external services. This consistency avoids repeated feature-engineering logic for each service at inference time, thereby improving computational efficiency and reducing system complexity.

The server generates prediction information by applying the trained time-series machine learning model to the most recent transaction sequences for each user and acquisition target.

The server reads, from the aggregated transaction table, the latest N transactions for a given user and acquisition target, reconstructs the corresponding time-series feature vectors using the same normalization and encoding as during training, and performs an inference pass through the trained model. The server obtains a predicted inter-acquisition interval in days and converts this interval to a predicted acquisition date by adding the interval to the current server time. The server stores these predicted intervals and predicted acquisition dates as prediction information in a prediction table keyed by user identifier and acquisition target identifier.

The server acquires price information and condition information from multiple external transaction services for each acquisition target that has a predicted acquisition date falling within a given time window. The server issues price queries to each service, specifying the canonical product identifier or normalized target name, and receives candidate offers with fields such as price, shipping cost, estimated delivery time, service provider rating, and return policy. The server computes an effective price index for each candidate by combining the price with other factors; for example, the server can calculate a weighted sum or ratio that subtracts expected rewards, adds shipping cost, and penalizes low service provider ratings by increasing the effective price. The server can then rank the candidates for each acquisition target based on the effective price index and select the candidate with the lowest or otherwise optimal index as part of recommendation information.

The server determines, for each acquisition target, recommendation information that includes at least a recommended acquisition time and recommended acquisition conditions. The recommended acquisition time may be the predicted acquisition date or a shifted date based on user preferences, such as notifying several days before the predicted date. The recommended acquisition conditions may include a selected external service, a selected offer, and constraints such as maximum acceptable price or minimum service provider rating. The server stores the recommendation information in structured form, along with the associated prediction information, as structured internal data that can be used for both computation and natural-language generation.

The server generates structured internal data by constructing a record structure or hierarchical object that includes, for a given user, a list of acquisition targets, predicted acquisition dates, effective price indices, selected offers, and summarizing metrics. The server ensures that this structured internal data is normalized to a defined schema so that downstream processes can consume it without additional reformatting. This structured representation improves data reuse and reduces the need for repeated custom formatting before calling external services.

The server dynamically creates a prompt sentence for a generative AI model by embedding the structured internal data into an instruction sentence. The server includes, in the instruction sentence, directives that specify notification targets, explanation detail level, writing style, and length constraints. For example, the server can include language instructing the generative AI model to generate a concise and friendly reminder message under a specific word limit, to mention only acquisition targets predicted within a certain time frame, and to reference only the best offer per acquisition target. Because the server programmatically constructs prompt sentences with embedded structured data, the server can tightly control how much information is exposed to the generative AI model and how the model is expected to respond.

In one example, the server constructs a prompt sentence such as:

“You are an assistant that creates shopping notifications. Based on the following purchase predictions, generate a short, friendly message in English that tells the user when they are likely to need each item, and which provider currently offers the best price. Predictions: [item A: next purchase in 5 days, best price 10.50 from provider X; item B: next purchase in 12 days, best price 8.30 from provider Y]. Keep the message under 150 words.” In another example, the server constructs a prompt sentence such as:

“Using the following predicted purchase dates and best offers, generate a concise shopping reminder message for the user. Explain which items are likely to run out soon and mention the best current price and provider for each item. Data: [toilet paper: next purchase in 5 days, best price 12.50; detergent: next purchase in 12 days, best price 9.80; coffee: next purchase in 2 days, best price 7.40]. Keep the tone polite and helpful.”

The server inputs the prompt sentence and the relevant portions of the structured internal data into a generative AI model that is accessible via an application programming interface. The generative AI model, which may be a large language model configured on a dedicated computing server, processes the input tokens and generates natural-language text in response.

The server receives the generated explanatory sentence or proposal sentence and may apply post-processing such as truncation to enforce length constraints, or substitution to align terminology with application-specific vocabulary. The server then transmits the generated sentence to the user terminal via the communication function, such as a messaging interface in a communication service.

The terminal receives messages from the server and displays them within a messaging interface or dedicated application. The user can read, on the terminal, that certain acquisition targets such as household consumables are predicted to be needed within a specified number of days, and that particular offers from certain providers are recommended. The user can interact with the terminal to select options such as proceeding to the external transaction service for purchase, postponing the recommendation, or dismissing the message. The terminal then sends response information to the server, indicating, for example, whether the recommendation was accepted, ignored, or postponed, and, if applicable, the amount of postponement.

The server uses the response information to generate relearning data. For example, if the user postpones an acquisition by a number of days relative to the predicted acquisition date, the server can treat the eventual acquisition date as the effective target in the training data. The server updates transaction history records with corrected or refined dates based on observed user behavior and aggregates these records into new time-series segments. The server then executes a relearning process on the time-series machine learning model, either periodically or when sufficient new data has accumulated. During relearning, the server uses the same architecture and loss function as in the initial training, but starts from the existing model weights rather than from random initialization, so that the model adapts incrementally to shifts in user behavior. This feedback-driven retraining reduces prediction errors over time and increases robustness to behavioral changes.

The use of unified time-axis conversion, structured feature extraction, and consistent time-series modeling results in several technical effects. Because transaction data from multiple external services is normalized once into a common schema and a unified time representation, the server avoids repeated conversions at inference time, reducing processing time and conservation of computational resources. Because the time-series machine learning model is trained on richer feature vectors than simple intervals, the model can capture seasonal patterns, varying quantities, and price-related behavior, improving prediction accuracy relative to baseline rule-based schedulers. Because the server uses structured internal data and dynamically constructed prompt sentences, calls to the generative AI model become more efficient and deterministic, reducing token usage, latency, and variance in output quality. These improvements enhance the functioning of the computer system as a whole, over and above merely automating human reminder behavior.

In alternative embodiments, the server may employ other time-series architectures such as gated recurrent units or transformer-based sequence models. The server may change hyperparameters such as embedding dimension, number of layers, or hidden size to balance prediction accuracy and computational cost. The server may also apply regularization techniques such as dropout or weight decay to reduce overfitting, or perform data augmentation at the sequence level, for example, by adding small amounts of noise to intervals to increase model robustness. The choice of architecture and hyperparameters can be adapted based on hardware resources; for example, if a graphics processing unit is available, the server can train deeper models or larger embeddings while maintaining acceptable training time.

In another variation, the server can partition users into segments based on similarity of acquisition patterns, and train separate models per segment. The server may use clustering algorithms to group users and maintain segment-level parameters that capture shared behaviors. This segmentation can further improve prediction quality with moderate additional storage, and allows the server to scale model training and inference efficiently.

The server may also vary the calculation of the effective price index. In one embodiment, the server explicitly multiplies the unit price by a factor inversely proportional to the service provider rating and adds a penalty term for long expected delivery times. In another embodiment, the server can train a separate regression model that outputs an effective cost score using features such as base price, shipping, rating, and historical user preferences. In both cases, the server systematically combines price and condition information with user preferences to generate recommendation information, thereby reducing the need for manual evaluation by the user and minimizing redundant network visits to multiple providers.

The server, terminal, and user thus interact in a way that is rooted in specific data structures, concrete machine learning architectures, and structured communication protocols, rather than in generic business logic. The system improves the operation of the underlying computing infrastructure by reducing duplicated preprocessing, enabling efficient and scalable time-series prediction, and tightly integrating structured prediction outputs with generative AI text generation under programmatically enforced constraints.

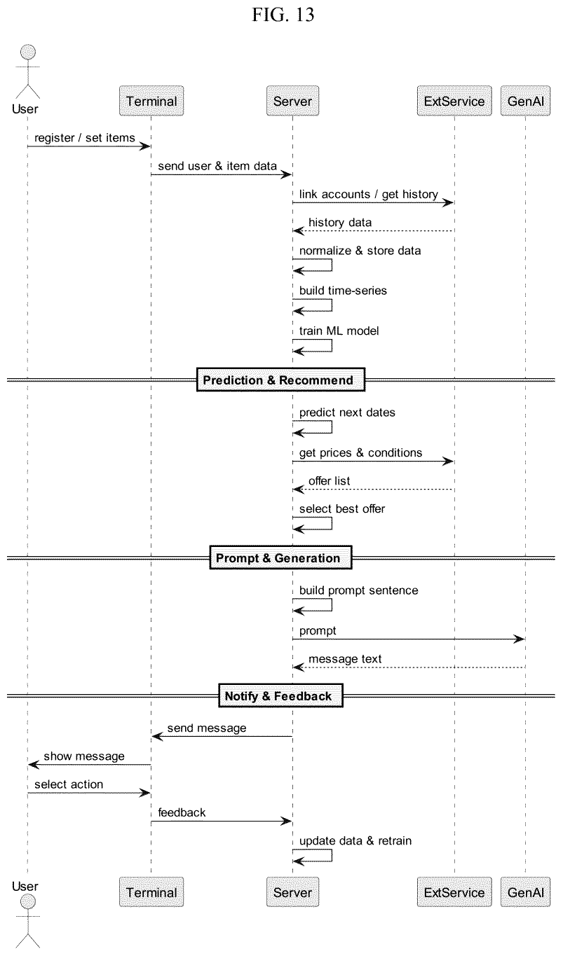

The following describes the processing flow using FIG. 13.

### Step 1:

Server receives and stores user registration and account-linking information.

Server takes, as input, user registration data (such as email, password, and region) and account-linking data from external communication and transaction services (such as authorization codes or access tokens). Server performs data validation on the registration data, hashes the password using a secure algorithm, and creates a user record in a user table of a database. Server then exchanges authorization codes with external services via network calls to obtain access tokens and service-specific user identifiers. Server associates the internal user identifier with each external service identifier and access token, and stores this association as identification information in an account-linking table. The output of this step is a set of persistent database records that link the user's communication function and transaction function in a unified internal representation.

### Step 2:

Terminal presents a configuration interface for periodic acquisition targets and user preferences.

Terminal takes, as input, user actions such as selecting “add recurring item,” entering an item name, specifying an acquisition cycle in days, and setting notification preferences (for example, “notify 3 days before predicted date” or “only if price is lower than last time”). Terminal converts these user actions into structured configuration data (item name, category, cycle, and preference flags) and sends the data to the server through a secure network connection. The output of this step is structured configuration data delivered to the server in a defined request format.

### Step 3:

Server normalizes acquisition target information and stores target management data.

Server takes, as input, the configuration data from the terminal that includes free-form item names, acquisition cycles, and preference values. Server performs text normalization (lowercasing, trimming whitespace, removing special symbols) and maps item names to standardized categories using an internal lookup table or a simple matching algorithm. Server may query an external transaction service to resolve the normalized item to a canonical product identifier, based on keyword search results and basic matching criteria. Server converts the acquisition cycle into a standardized unit (for example, days as an integer) and stores the normalized item attributes, canonical identifiers, and cycles as target management records in a dedicated database table. The output of this step is a set of normalized target management entries that the prediction pipeline can consume without additional parsing.

### Step 4:

Server acquires and preprocesses transaction history from external transaction services.

Server takes, as input, access tokens and service-specific user identifiers from the account-linking table. Server calls external transaction APIs to request order history, receiving transaction records including timestamps, item codes, quantities, prices, and supplementary attributes. Server parses the received data and writes it into a raw history table with typed columns. Server performs missing-value completion by applying rule-based checks (for example, inferring default quantity if omitted) and discards or flags records with invalid or nonsensical timestamps. Server then converts all timestamps to a unified time axis (for example, to a single time zone and standard time format) and computes derived values such as day-of-week or month indices. The output of this step is a cleaned and time-normalized transaction history table suitable for time-series analysis.

### Step 5:

Server constructs time-series learning data from normalized transaction history.

Server takes, as input, the cleaned transaction history table along with the target management table. Server groups history records by user and acquisition target and sorts them by timestamp. Server then computes inter-acquisition intervals by subtracting consecutive timestamps to obtain intervals in days. Server extracts feature vectors for each transaction such as normalized quantity, normalized unit price, binary flags for promotions, and categorical encodings of item category and season. Server transforms categorical values into integer indices and optionally into dense numeric representations using a predefined mapping or embedding indices. Server segments the sequences into fixed-length windows, padding or truncating as necessary, and aligns each window with a corresponding target value (the next interval in days). The output of this step is a collection of structured training samples consisting of input feature sequences and associated target intervals, stored as arrays or structured records that can be passed directly to a machine learning training routine.

### Step 6:

Server trains a time-series machine learning model on the learning data.

Server takes, as input, the structured training samples generated in Step 5. Server initializes a time-series model such as a recurrent neural network or sequence model with explicit architecture parameters (for example, embedding dimension, number of recurrent layers, hidden units per layer). Server defines a loss function such as mean squared error between predicted intervals and actual intervals, and selects an optimization algorithm such as a gradient-based optimizer with specified learning rate and batch size. Server iteratively processes batches of training samples: for each batch, server performs a forward pass through the model to compute predicted intervals, computes the loss, performs backpropagation to calculate gradients with respect to model parameters, and updates the parameters according to the optimization rule. Server monitors performance on a validation subset, adjusts learning rate or stops training early when validation loss no longer improves, and then saves the resulting trained model and metadata to persistent storage. The output of this step is a trained time-series machine learning model that can predict the interval until next acquisition for each target sequence.

### Step 7:

Server performs prediction of next acquisition timing for each acquisition target.

Server takes, as input, the trained model parameters and the latest transaction history and target management records for each user. Server constructs, for each user-target pair, a current feature sequence representing the most recent N transactions, using the same feature extraction and encoding pipeline as in training. Server passes the feature sequence into the trained model to compute a predicted inter-acquisition interval in days. Server reads the current time from its system clock and adds the predicted interval to obtain an estimated next acquisition date. Server then stores the predicted interval and predicted date as prediction information in a prediction table, keyed by user identifier and acquisition target identifier, optionally including a confidence measure derived from model output or ensemble statistics. The output of this step is up-to-date prediction information for each acquisition target.

### Step 8:

Server acquires price and condition information and computes effective price indices.

Server takes, as input, the prediction information table and the target management table.

Server identifies acquisition targets whose predicted acquisition dates fall within a configurable time window, and for each such target server sends price queries to multiple external transaction services using canonical identifiers. Server receives lists of candidate offers containing price, shipping cost, estimated delivery time, provider rating, and other conditions. Server computes, for each candidate, an effective price index by combining price and condition values according to an algorithm, such as a weighted sum that includes base price plus shipping cost minus discounts, with multiplicative or additive penalties for low ratings or long delivery times. Server ranks candidates for each acquisition target based on the effective price indices and selects at least the best candidate or a subset of top candidates as part of recommendation information. The output of this step is recommendation information containing recommended offers and associated metrics for each relevant acquisition target.

### Step 9:

Server assembles structured internal data from prediction and recommendation information.

Server takes, as input, the prediction table and the recommendation information for each user.

Server merges these tables by user identifier and acquisition target identifier to generate, for each user, a structured object or record that includes target identifiers, predicted acquisition intervals, predicted dates, effective price indices, selected offers, and user-preference indicators. Server arranges this data according to a defined schema, such as an ordered list of records with standardized field names and units, and stores it temporarily in memory or a staging table. Server ensures that only the data relevant to upcoming recommendations for a given user is included in each structured object. The output of this step is structured internal data describing, in a normalized and compact form, the predictive and recommendation state for each user.

### Step 10:

Server constructs a prompt sentence for the generative AI model based on structured internal data.

Server takes, as input, the structured internal data generated in Step 9 and user-specific settings such as preferred language, tone, and desired level of explanation. Server converts the structured internal data into textual descriptions, for example, by summarizing each acquisition target as “item name, predicted in X days, best price Y from provider Z,” and concatenates these descriptions. Server then builds an instruction sentence specifying that the generative AI model should generate a shopping reminder message, including details such as “short and friendly,” “mention only items needed within N days,” and “keep under M words.” Server combines the instruction sentence and the textual representation of the structured internal data into a single prompt sentence. For example, server may generate: “You are an assistant that creates shopping notifications. Based on the following purchase predictions, generate a short, friendly message in English that tells the user when they are likely to need each item, and which provider currently offers the best price. Predictions: [item A: next purchase in 5 days, best price 10.50 from provider X; item B: next purchase in 12 days, best price 8.30 from provider Y]. Keep the message under 150 words.”

The output of this step is a fully constructed prompt sentence tailored for input to the generative AI model.

### Step 11:

Server invokes the generative AI model and obtains an explanatory or proposal sentence.

Server takes, as input, the prompt sentence produced in Step 10. Server sends the prompt sentence to a generative AI model endpoint via a network interface, optionally including model configuration parameters such as maximum token count or temperature. Server receives a generated text response from the generative AI model, which includes a natural-language explanatory sentence or proposal sentence describing upcoming acquisitions and recommended offers. Server may apply post-processing such as trimming extra whitespace, enforcing a maximum character length, or adjusting certain phrases according to predefined lexical rules. The output of this step is a finalized message body that can be delivered to the user through the communication function.

Step 12: Server transmits the generated message to the user terminal and records delivery context.

Server takes, as input, the generated message body and the user's communication account identification information. Server constructs a message payload that includes the generated text and, optionally, links or buttons that direct the user to external transaction services or allow the user to defer or decline the recommendation. Server sends this payload through the communication function, such as a messaging platform interface, to the terminal. Server records metadata about the transmission, including timestamp, target user identifier, and message type, in a message-log table for later analysis. The output of this step is a delivered notification on the terminal and an associated log entry on the server.

### Step 13:

Terminal presents the message and captures user feedback.

Terminal takes, as input, the message payload received from the server via the communication function. Terminal renders the generated explanatory or proposal sentence in a user interface, presenting interactive elements such as “buy now,” “remind me later,” or “skip.” User reads the message and selects an action, for example pressing “remind me in 7 days” or “skip this recommendation.” Terminal translates the user's action into structured feedback data, including the chosen action type and parameters (such as deferral interval), and transmits this feedback to the server over the network. The output of this step is a feedback request sent from the terminal to the server containing explicit user response information.

### Step 14:

Server generates relearning data and updates the time-series model based on feedback.

Server takes, as input, the response information produced in Step 13 and the existing transaction history and prediction records. Server interprets the feedback according to predefined rules; for example, if the user postpones a recommendation by D days, the server adjusts the effective target interval for that instance to include the postponement. Server inserts or updates records in the transaction history table to reflect the effective acquisition date or new behavioral pattern. Server then aggregates the updated history into new time-series segments, consistent with the feature extraction and segmentation procedure used in Step 5, and assembles these segments into relearning data. Server initiates a retraining operation on the time-series machine learning model using the relearning data, starting from current model weights and performing additional gradient updates. Server evaluates the updated model on recent validation data to confirm performance improvements, and then stores the updated model parameters as a new version. The output of this step is an incrementally refined time-series model that better reflects current user behavior, thereby improving subsequent prediction accuracy and reducing future prediction errors.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In network-based commerce systems, conventional recommendation engines typically treat purchase timing prediction, price comparison, and message generation as disjoint processes. Backend components often execute simple rule-based schedulers for purchase reminders, separate scripts for price scraping, and static templates for user-facing messages. As a result, several technical problems arise in the computing environment. First, a processor that independently executes timing estimation and price collection without a unified contextual model often performs redundant data access and duplicated computation. Purchase history is repeatedly scanned by different modules, and price information is repeatedly normalized by separate routines, which increases memory traffic, processor load, and latency. This fragmented architecture leads to inefficient utilization of storage, communication bandwidth, and computation resources.

Second, existing systems generally generate user-facing recommendation messages by simple string concatenation or fixed templates that are unaware of current model predictions, real-time market conditions, or user emotion states. Because the message generation layer is not systematically conditioned on the internal analytic context, a processor cannot effectively encode complex, multi-factor state (such as predicted next acquisition time, current minimum price, and user sentiment) into text. This limits the expressiveness and adaptability of the user interface and forces application developers to manually maintain large sets of templates, which is error-prone and computationally rigid.

Third, many systems do not provide a feedback loop that ties user responses to specific internal states and generative prompts. Even when a system collects click or purchase logs, it usually does not associate these logs with the exact prompt sentence and corresponding generated proposal sentence that were delivered. As a consequence, the processor cannot systematically improve its timing prediction models or its prompt construction logic based on observed outcomes. This prevents continuous optimization of machine learning parameters and prompt engineering, and leads to suboptimal performance over time.

Fourth, user context in conventional systems is often limited to transactional data. Emotion signals derived from communication applications are either ignored or processed in isolation from purchase prediction and price comparison pipelines. This separation prevents the processor from using emotion state as a first-class signal within a unified recommendation computation, and therefore the system cannot tailor proposal timing and content to the user's real-time psychological state in a technically integrated manner.

Accordingly, there is a need for an improved computer-implemented system in which a processor (i) unifies acquisition-history analysis, real-time price computation, and emotion analysis into a coherent context, (ii) systematically converts that context into a prompt sentence for a generative AI model, (iii) controls the generative AI output through content checking, and (iv) uses logged prompts, generated proposal sentences, and user response results to update both timing prediction models and prompt-generation rules. Such a system should reduce redundant computations and data access, improve the technical quality and relevance of generated messages, and provide a self-improving loop that enhances overall computational efficiency and predictive accuracy in a networked commerce environment.

The specific processing by the specific processing unit 290 of the data processing device 12 in Application Example 2 is realized by the following means.

The present invention provides a server comprising a processor configured to acquire and store, in a unified storage device, user identification information for a communication application and a commercial transaction platform so as to establish a persistent association between the communication application and the commercial transaction platform, to receive, via a user interface, attribute information and acquisition interval information for acquisition targets repeatedly acquired by a user and to register the received information as structured records, to obtain past acquisition history information from the storage device and to perform statistical computation processing and machine learning processing on the past acquisition history information so as to generate acquisition frequency information and predicted acquisition times for the acquisition targets, to obtain transaction price information for the acquisition targets from a plurality of commercial transaction platforms in real time and to normalize and store the transaction price information as price list information, to execute numerical computation processing on the price list information so as to specify a minimum price and corresponding transaction source information and to compute discount rate information relative to a reference price, to perform natural language processing on expression information obtained from the user via the communication application so as to calculate emotion type information and emotion strength information and to store the emotion type information and the emotion strength information as emotion state information, to construct context information including the predicted acquisition times, the minimum price, the discount rate information, the transaction source information, the acquisition frequency information, and the emotion state information, to generate, based on the context information, a prompt sentence in a natural language for generation of a proposal sentence by a generative artificial intelligence model, to transmit the prompt sentence to the generative artificial intelligence model, to receive a candidate proposal sentence from the generative artificial intelligence model and to perform content checking processing on the candidate proposal sentence so as to determine a proposal sentence indicating a recommended acquisition time and a recommended transaction source, to transmit the proposal sentence to a user terminal via the communication application so that the proposal sentence is displayed as a notification, and to store, in association with each other in the storage device, the prompt sentence, the proposal sentence, and a response result of the user to the proposal sentence and to update a prompt-generation rule and learning parameters of the machine learning processing based on stored histories. This enables integrated and context-aware recommendation processing in which the processor reduces redundant data access and computation by unifying acquisition-history analysis, price computation, and emotion analysis, dynamically conditions a generative AI model by means of a structured prompt sentence to produce technically relevant proposal sentences, and continuously improves timing prediction accuracy and prompt construction efficiency by feeding back logged prompt-response pairs into model training and rule updating, thereby achieving improved computational performance and adaptivity of the overall network-based commerce system.

The term “processor” refers to a hardware-based or virtual information processing element, such as a central processing unit, microprocessor, or execution core provided by a computing resource, that executes instructions to perform logical, arithmetic, control, and input/output operations.

The term “communication application” refers to a software application or service that enables a user to transmit and receive messages, including text, audio, image, or other digital content, over a communication network.

The term “commercial transaction platform” refers to a network-accessible system or service that provides functions for listing, searching, purchasing, and managing goods or services through electronic commerce.

The term “user identification information” refers to data that uniquely or semi-uniquely identifies a user or user account within a communication application or a commercial transaction platform, including identifiers such as user IDs, account IDs, or authentication tokens.

The term “storage device” refers to any physical or virtual memory or storage resource, such as a database, non-volatile memory, or distributed storage, capable of storing data under control of the processor.

The term “user interface” refers to a hardware and software combination, including display screens, input controls, and interaction logic, that allows a user to input information and receive output from the system.

The term “acquisition target” refers to an item, product, service, or other unit of value that a user obtains or purchases repeatedly through one or more commercial transaction platforms.

The term “attribute information” refers to descriptive data of an acquisition target, including but not limited to name, category, specification, or other classification or descriptive parameters.

The term “acquisition interval information” refers to information indicating a temporal interval, such as a period or frequency, between successive acquisitions or purchases of an acquisition target.

The term “acquisition history information” refers to records of past acquisitions or purchases of acquisition targets by a user, including data such as acquisition dates, item identifiers, quantities, and prices.

The term “statistical computation processing” refers to operations in which the processor applies statistical methods, such as aggregation, averaging, variance calculation, or distribution estimation, to numerical or categorical data.

The term “machine learning processing” refers to operations in which the processor executes an algorithm that adjusts internal parameters based on training data so as to model patterns or relationships and generate predictions or classifications.

The term “feature information” refers to numerical or categorical values derived from acquisition history information that represent characteristics relevant to prediction or analysis, such as acquisition intervals or trend indicators.

The term “acquisition frequency information” refers to data that indicates how often or at what periodicity an acquisition target is typically acquired by a user, derived from acquisition history information.

The term “transaction price information” refers to data representing prices or related monetary values for an acquisition target, obtained from one or more commercial transaction platforms.

The term “price list information” refers to a structured collection of normalized transaction price information, including, for each acquisition target and platform, at least one price value and associated metadata.

The term “minimum price” refers to the lowest price value for an acquisition target among a plurality of transaction price values obtained from different sources.

The term “transaction source information” refers to data identifying a particular commercial transaction source, such as a platform or seller, from which a transaction price is obtained.

The term “discount rate information” refers to data indicating a relative reduction of a current price compared with a reference price, expressed as a rate or percentage.

The term “reference price” refers to a baseline price value used for comparison with current prices, derived from historical price data or a predefined rule.

The term “predicted acquisition time” refers to a time or time range, estimated by computation including machine learning processing, at which a user is likely to next acquire an acquisition target.

The term “recommended acquisition time” refers to a time or time range calculated by the processor as an advantageous time for acquisition, taking into account predicted acquisition time, current prices, and discount information.

The term “expression information” refers to content generated or provided by a user through a communication application, including natural language text, that can be analyzed to infer an emotion state.

The term “natural language processing” refers to a set of computational techniques applied by the processor to analyze, interpret, and transform human language data such as text or speech.

The term “emotion type information” refers to categorical data representing a classification of a user's emotion state, such as positive, negative, or neutral.

The term “emotion strength information” refers to numerical or ordinal data indicating an intensity level of a detected emotion type.

The term “emotion state information” refers to combined data representing at least an emotion type and optionally an emotion strength for a user at a given time.

The term “context information” refers to a structured aggregation of multiple kinds of data, including at least predicted acquisition times, price-related information, and emotion state information, used as a basis for generating a prompt sentence.

The term “prompt sentence” refers to a natural-language instruction or query constructed by the processor and provided as input to a generative artificial intelligence model to guide generation of a proposal sentence.

The term “generative artificial intelligence model” refers to a computational model trained on data to generate new content, including natural-language text, conditioned on input such as a prompt sentence.

The term “candidate proposal sentence” refers to a natural-language text output by the generative artificial intelligence model in response to a prompt sentence, before content checking or final selection.

The term “proposal sentence” refers to a finalized natural-language text, derived from a candidate proposal sentence, that indicates at least a recommended acquisition time and a recommended transaction source to a user.

The term “content checking processing” refers to operations performed by the processor to evaluate a candidate proposal sentence for compliance with predefined constraints, including correctness, safety, or policy requirements.

The term “user terminal” refers to an end-user computing device, such as a smartphone, tablet, or personal computer, capable of running a communication application and displaying notifications from the server.

The term “notification” refers to a message output at the user terminal, presented by a user interface element such as a pop-up, banner, or in-application message, to inform the user of content generated by the system.

The term “response result” refers to data representing a user's behavior or reaction to a proposal sentence, including actions such as viewing, clicking, purchasing, or ignoring.

The term “prompt-generation rule” refers to a set of conditions, templates, or algorithms that determine how context information is transformed into a prompt sentence.

The term “learning parameters” refers to adjustable numerical values within a machine learning model, such as weights and biases, that are updated during training to improve prediction or classification performance.

In one embodiment, a server, at least one terminal, and a communication network constitute a system that implements the claimed invention. The server includes at least one processor, a main memory, a non-volatile storage device, and a network interface. The terminal includes a processor, a user interface display, an input device, and a communication module. The server and the terminal communicate via a packet-based network.

The server executes an operating system and middleware, and runs application software modules implementing account association, history analysis, price computation, emotion analysis, context construction, prompt sentence generation, generative AI interaction, content checking, and model updating. The server stores structured data in a database management system executing on the storage device. In various embodiments, the server uses a relational database management system, a key-value store, or a combination thereof. The server stores purchase history, price snapshots, emotion logs, prompt sentences, proposal sentences, and user response results as records with explicitly defined schemas.

The terminal executes a communication application that provides a user interface to the user.

The terminal presents input fields and output messages on a display, and transmits user-generated content to the server via the communication application protocol. The user operates the terminal to input acquisition targets, purchase intervals, and other preferences, and to view proposal sentences transmitted from the server.

The server associates user identification information of a communication application and user identification information of a commercial transaction platform. The server stores mappings between such identifiers in the database as records including a communication-application identifier, a transaction-platform identifier, and authentication metadata. The server thereby maintains a normalized user identifier that uniquely identifies the user across different applications. This association reduces redundant authentication operations and decreases network traffic, because the server retrieves purchase history and price information using a single mapping rather than performing repeated credential exchanges.

The server stores acquisition targets and acquisition interval information entered by the user via the terminal. The server normalizes acquisition target names, assigns internal item identifiers, and stores acquisition interval information as numeric values representing days or other time units. The server may associate acquisition targets with categories and tags, which the server stores in dedicated tables. This structured storage enables efficient index-based retrieval by the processor and reduces the number of full-table scans for each computation.

The server obtains acquisition history information from commercial transaction platforms through application programming interfaces or through automated browsing controlled by the processor. The server stores raw acquisition history in a data structure including at least user identifier, item identifier, acquisition timestamp, quantity, and price. The server then transforms this raw history into processed acquisition history by computing acquisition intervals, cumulative counts, moving averages, and other statistical features. The server uses a numerical computing library, such as a matrix and table processing framework, to perform these computations efficiently. The server thereby reduces computation time compared with naive iteration by using vectorized operations on in-memory arrays.

The server configures a timing prediction module as a machine learning model. In one embodiment, the timing prediction module is a neural network implemented as a multi-layer architecture with an input layer, at least one hidden layer, and an output layer. The input layer receives feature vectors constructed from acquisition history, including at least the last acquisition interval, average interval over several acquisitions, recency of last acquisition, number of acquisitions, and optional seasonality features such as month encoded as numerical values. The hidden layer may be implemented as a fully connected layer, a recurrent layer, or a combination of these. The output layer outputs either a real-valued prediction of days until next acquisition or a probability distribution over future time windows.

The server trains the timing prediction model on historical data. The server defines a loss function, such as mean squared error for regression or cross-entropy for classification, and applies a gradient-based optimization algorithm such as stochastic gradient descent with adaptive learning rate. The server updates weight parameters of the model by computing gradients of the loss function with respect to the model parameters and performing iterative updates. The server may use techniques such as mini-batch training, regularization, and early stopping to stabilize training and avoid overfitting. This training procedure enables the model to learn non-linear relationships between features and acquisition timing that are not captured by simple threshold rules, thus improving prediction accuracy and reducing forecasting error.

The server collects transaction price information from multiple commercial transaction platforms. The server uses automated network requests to obtain current prices, including base price and shipping cost, for each acquisition target from multiple sources. The server limits the number of requests per unit time to each platform according to platform policies to prevent excessive network load. The server normalizes obtained prices by converting currencies to a base currency, handling different units or pack sizes, and calculating effective price per standard quantity. The server stores normalized prices as rows in a price list structure with indices on at least user identifier, item identifier, platform identifier, and timestamp.

The server computes a minimum price and related discount information by applying numeric operations to the price list. The server performs a search over the price list records for a given acquisition target and user, identifies the record with the smallest effective price, and computes a discount rate by comparing the current effective price with a reference price such as a historical average stored in the database. The server may compute reference prices using a sliding-window mean or median. These computations, performed as vectorized operations across multiple records, reduce processing time and memory access overhead compared with repeated individual comparisons.

The server analyzes expression information obtained from the user via the communication application. The expression information is typically natural language text messages. The server executes a natural language processing module that tokenizes the text, maps tokens to numerical representations, and applies a sentiment classification algorithm. In one embodiment, the server uses a neural network classifier with an embedding layer, one or more convolutional or recurrent layers, and a final softmax layer outputting emotion categories. The server may also compute an emotion strength score as a continuous value.

The server stores both emotion type and emotion strength in the database with a timestamp and user identifier. This enables later correlation of emotion with acquisition behavior and response to proposal sentences.

The server constructs context information by retrieving, for a particular user and acquisition target, the predicted acquisition time, the minimum price and corresponding transaction source, the discount rate, the acquisition frequency information, and the latest emotion state information. The server encodes this context information into a structured representation within the server memory. The server then transforms this structured representation into a natural-language prompt sentence.

In one embodiment, the server uses a template-based prompt generator that inserts specific values into a linguistic pattern. For example, the server generates a prompt sentence such as: “The user regularly buys toilet paper every 30 days. The last purchase was on 2026 Jan. 1. The predicted next purchase date is 2026 Jan. 31. Currently, an online marketplace offers toilet paper at 980 units of currency, which is about 20% cheaper than the usual price. The user's emotion is positive. Using this information, generate a short, friendly recommendation message suggesting that now is a good time to buy toilet paper on that online marketplace, including a brief explanation.”

In another embodiment, the server uses a rule-based system that selects among multiple prompt patterns depending on emotion type, discount magnitude, or prediction confidence. For example, when the discount rate exceeds a threshold, the server emphasizes savings in the prompt sentence. When the emotion is negative, the server instructs the generative AI model to adopt a supportive tone. This conditional prompt construction is a non-conventional step that integrates machine-learned predictions, price analytics, and emotion analysis into the instructions given to a generative AI model.

The server transmits the prompt sentence to a generative AI model. The generative AI model may be hosted by an external service or executed locally on the server. The generative AI model is typically a neural network with multiple layers configured for sequence-to-sequence or language modeling tasks. The model receives the prompt sentence as input and produces a candidate proposal sentence as output. The server processes the candidate proposal sentence and performs content checking. The server may apply rule-based filters to ensure that the candidate proposal sentence includes a recommended acquisition time and a recommended transaction source, does not include prohibited content, and remains consistent with context values such as current price and discount rate.

If the candidate proposal sentence fails content checking, the server may adjust the prompt sentence or apply an alternative template to request a revised proposal from the generative AI model. The server thus exercises control over the generative AI behavior through its prompt engineering logic and content checking procedures. This control reduces the risk of inconsistent or non-responsive messages and improves the reliability of the system.

The server transmits the final proposal sentence to the terminal via the communication application. The terminal displays the proposal sentence as a notification or chat message. The user sees a message that indicates, in natural language, the recommended acquisition time and recommended transaction source based on the computed context. The user may respond by clicking a link embedded in the message, by sending a text response, or by ignoring the message. The terminal forwards such responses to the server.

The server records the prompt sentence, the proposal sentence, and the user's response result together in the database. The server thus creates prompt-response pairs linked with user actions. The server uses this logged data to improve both timing prediction and prompt sentence generation. For example, the server may compute conversion rates for different prompt templates and weight adjustments of prompt-generation rules accordingly. The server may also retrain the timing prediction model using patterns of early or late purchases relative to predicted acquisition times to reduce prediction error.

In another embodiment, the server adjusts learning parameters of the timing prediction model based on user response feedback. If users consistently purchase earlier than predicted for a particular acquisition target, the server shifts the prediction model's parameters to decrease the expected time until next acquisition. If users ignore proposal sentences at certain times or in certain contexts, the server may adjust thresholds for when to issue proposal sentences.

These adaptive updates improve computational resource utilization by avoiding unnecessary notifications and focusing server-side computation on situations with higher expected benefit. The system provides technical improvements over conventional systems. By unifying account association, acquisition history analysis, price computation, emotion analysis, context construction, and generative AI interaction within a single server pipeline, the system reduces redundant database queries and consolidates intermediate data into shared data structures. This reduces input/output overhead and processing time. The timing prediction model improves upon rule-based schedulers by learning non-linear patterns in acquisition behavior, which enhances the precision of acquisition-time estimation and lowers the rate of premature or delayed notifications.

The integration of emotion state information into the context that drives prompt generation allows the server to adapt communication style and notification timing based on user mood. This functionality is not a mere automation of human decision-making, because the server applies high-dimensional feature representations and neural network computations that a human could not perform in real time across many users and items. The use of generative AI is also technically constrained by prompt sentence design and content checking steps that enforce consistency with internal model outputs and structured data. The server therefore uses generative AI as a computational component within a controlled pipeline rather than as a generic text generator.

In one alternative embodiment, the server employs a recurrent neural network architecture such as a long short-term memory network or a gated recurrent unit network for timing prediction. The server encodes an entire sequence of past acquisition intervals and prices into a hidden state. The hidden state captures temporal dependencies that may include seasonality, promotional cycles, or user-specific behavior changes. The server trains this network using a sequence of feature vectors as input and the next acquisition interval as output. The recurrent architecture enables the server to capture long-range temporal patterns, which improves prediction of rare but systematic behaviors such as bulk purchases before holidays. In another embodiment, the server integrates a transformer-based language model as the generative AI component. The server may fine-tune the language model on a corpus of historical proposal sentences and successful responses, using supervised training to align the model with the desired style and structure. The server may design the prompt sentence to include explicit markers for required elements such as time, price, and platform, and the model is trained to output sentences conforming to those markers. The server thereby improves the conformity of generated sentences to the system's technical requirements.

The system can also be implemented in a distributed configuration in which multiple servers share computation. For example, one server may specialize in acquisition history analysis and timing prediction, while another server specializes in price collection and another in generative AI interaction. The servers exchange structured context information through an internal network protocol. This modular configuration allows for independent scaling of computationally intensive components such as generative AI processing and neural network training.

The system, across these embodiments, improves computer technology by reducing redundant computation, optimizing data flows, and integrating predictive models and generative AI into a context-aware pipeline. The unified architecture decreases latency between acquisition of raw data and delivery of actionable messages to users, and the feedback loop continuously improves model parameters and prompt generation rules using logged data. As a result, the server achieves more accurate predictions, faster processing times, and reduced communication load on both external platforms and user terminals, while maintaining tight control over the generative AI output through prompt sentence construction and content checking.

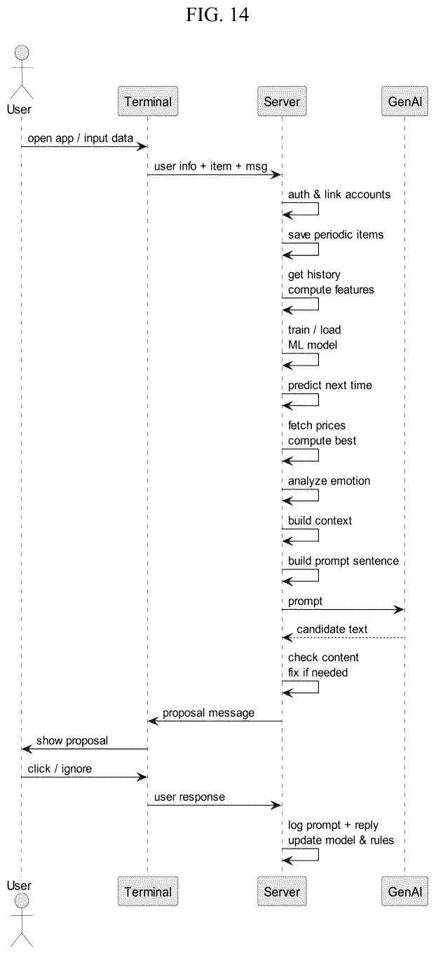

The following describes the processing flow using FIG. 14.

### Step 1:

User operates the terminal to launch a communication application and an associated shopping interface.

Terminal displays input fields for communication-application ID and commercial-platform account information.

User inputs a communication-application identifier and transaction-platform credentials and confirms submission.

Terminal sends, as input to the server, a data set including the communication-application identifier, the transaction-platform identifier, and authentication information.

Server receives this input and performs authentication with the transaction platform and validation with the communication application.

Server writes, as output, a normalized user record to a storage device, the record including a unified internal user ID and a mapping between the communication-application identifier and the transaction-platform identifier.

### Step 2:

User operates the terminal to open a “Periodic Purchases” screen.

Terminal requests, as input to the server, the user's current periodic acquisition-target settings using the internal user ID.

Server retrieves, as input, the user ID and queries the storage device for any existing periodic acquisition-target records.

Server returns, as output to the terminal, a list of stored acquisition targets and intervals or an empty list.

Terminal displays the list and input fields for new acquisition targets and acquisition intervals.

User inputs, as new data, attribute information (for example, item name and category) and acquisition interval information (for example, days between acquisitions) for each acquisition target.

### Step 3:

Terminal assembles the user-input attribute information and acquisition interval information into a structured message.

Terminal sends, as input to the server, this structured message including the internal user ID and one or more acquisition-target entries.

Server receives the message and parses the acquisition-target entries.

Server performs data processing by normalizing item names, assigning or confirming internal item identifiers, and converting interval expressions into numerical values.

Server writes, as output, normalized acquisition-target records into a periodic-acquisition table in the storage device, each record associated with the internal user ID and containing item identifier and interval value.

### Step 4:

Server initiates a background acquisition-history collection process.

Server uses, as input, stored mappings between internal user IDs and transaction-platform identifiers.

Server calls application programming interfaces or automated browsing scripts of commercial transaction platforms to obtain raw acquisition history data, including acquisition timestamps, item identifiers, quantities, and prices.

Server receives, as input, arrays of raw acquisition-history entries.

Server performs data processing by filtering out invalid entries, converting timestamp strings to time representations, and mapping external item identifiers to internal item identifiers.

Server writes, as output, standardized acquisition-history records into a history table in the storage device, each record linked to an internal user ID and an internal item identifier.

### Step 5:

Server initiates an acquisition-history preprocessing operation.

Server reads, as input, acquisition-history records for a given user and item from the history table.

Server sorts the acquisition-history records by acquisition timestamp and computes time intervals between consecutive acquisitions by subtracting earlier timestamps from later timestamps.

Server generates, as output, enhanced history records including base acquisition data plus derived fields such as acquisition-interval values, cumulative acquisition count, and moving-average interval metrics.

Server stores the enhanced records in a processed-history table or keeps them in memory as structured arrays for further computation.

### Step 6:

Server prepares training data for a timing-prediction model.

Server takes, as input, processed-history records for each acquisition target and user.

Server constructs feature vectors for each acquisition event, the vectors including at least last-interval value, average-interval value, number of past acquisitions, elapsed time since last acquisition, and optionally temporal features such as month and day-of-week values.

Server sets, as target output for training, either the next-interval value or a label indicating whether a new acquisition occurred within a defined future time window.

Server assembles, as output, a training dataset consisting of many feature-target pairs, which the server stores or forwards to a machine-learning module.

### Step 7:

Server configures a timing-prediction model as a neural network.

Server uses, as input, a model specification including number of layers, number of units per layer, activation functions, and output type.

Server initializes model parameters, such as weights and biases, with random or heuristic values.

Server executes a training algorithm that repeatedly reads mini-batches of feature-target pairs from the training dataset.

Server computes, for each mini-batch, predicted outputs and a loss value, for example, a mean squared error between predicted and actual interval or a cross-entropy between predicted and actual class.

Server computes gradients of the loss with respect to model parameters and updates the parameters according to an optimization rule, such as stochastic gradient descent with momentum.

Server outputs, upon completion of training, a trained timing-prediction model stored in a model repository with an identifier that links the model to a user or an item group.

### Step 8:

Server executes an inference operation for predicting next acquisition times.

Server uses, as input, the trained timing-prediction model parameters and the latest processed-history record for a given user and item.

Server constructs a current feature vector, including at least the most recent acquisition-interval value and the elapsed time since the last acquisition event.

Server feeds this feature vector through the timing-prediction model and obtains, as intermediate output, a predicted next-interval value or a probability distribution over discrete time segments.

Server converts this predicted value or distribution into a concrete predicted acquisition time by adding the predicted interval to the last acquisition timestamp or by selecting a time segment with maximum probability.

Server writes, as output, a predicted acquisition time entry to a prediction table in the storage device, associating the predicted acquisition time with the user and item.

### Step 9:

Server initiates a price-collection operation.

Server uses, as input, the list of acquisition targets from the periodic-acquisition table and the mapping between internal item identifiers and external platform item identifiers.

Server sends network requests to multiple commercial transaction platforms to obtain, as input, current price data, including base price, shipping cost, and currency.

Server receives price data responses and performs data processing by converting currency values to a base currency, normalizing pack sizes to a standard unit, and computing effective price per unit quantity.

Server stores, as output, normalized price records in a price list structure with fields including user identifier, item identifier, platform identifier, effective price, and timestamp.

### Step 10:

Server executes a price-comparison operation.

Server uses, as input, normalized price records for a particular user and item from the price list structure.

Server performs numeric operations by scanning or filtering records belonging to the target item and selecting the record with the minimal effective price.

Server retrieves, as intermediate output, the minimal-price record and the associated platform identifier.

Server also reads, as input, historical price data for the same item to compute a reference price, such as a time-window average.

Server computes, as output, a discount rate by comparing the current minimal effective price against the reference price, and records the minimal price, platform identifier, and discount rate in a best-price table linked to the user and item.

### Step 11:

User interacts with the communication application on the terminal and writes a message such as a natural-language statement of mood or intention.

Terminal transmits, as input to the server, an expression payload including at least the internal user ID and the text of the message.

Server receives the expression payload and passes the text through an emotion-analysis module.

Server performs natural-language processing operations such as tokenization, embedding transformation, and sentiment classification using a trained classifier model.

Server obtains, as output, an emotion type and an emotion strength score representing the user's emotion state.

Server stores this emotion state information in an emotion-log table in the storage device, linked to the user and timestamp.

### Step 12:

Server constructs context information for a particular user and acquisition target.

Server uses, as input, the predicted acquisition time from the prediction table, the minimal price and discount rate from the best-price table, the acquisition frequency information from the processed-history table, and the latest emotion state information from the emotion-log table.

Server assembles these values into an internal structured context object, including at least item identifier, typical interval, last acquisition time, predicted acquisition time, current best price, discount percentage, associated platform identifier, and emotion type.

Server generates, as output, a complete context representation stored temporarily in memory or in a context table for use in subsequent prompt-sentence generation.

### Step 13:

Server generates a prompt sentence from the context information.

Server uses, as input, the context object containing timing, price, and emotion data.

Server selects a prompt pattern according to conditional rules that depend on attributes such as discount magnitude and emotion type.

Server inserts context values into the selected pattern, forming a natural-language instruction addressed to a generative AI model.

Server produces, as output, a prompt sentence such as:

“The user regularly buys toilet paper every 30 days. The last purchase was on 2026 Jan. 1. The predicted next purchase date is 2026 Jan. 31. Currently, an online marketplace offers toilet paper at 980 units of currency, which is about 20% cheaper than the usual price. The user's emotion is positive. Using this information, generate a short, friendly recommendation message suggesting that now is a good time to buy toilet paper on that online marketplace, including a brief explanation.”

Server writes the prompt sentence into a prompt-log table along with identifiers of the associated context elements.

### Step 14:

Server interacts with a generative AI model.

Server uses, as input, the prompt sentence and model configuration parameters such as maximum length and temperature.

Server transmits the prompt sentence to the generative AI model via a network interface if the model is externally hosted or through an internal interface if the model is locally executed.

Server receives, as output, a candidate proposal sentence generated by the generative AI model in response to the prompt sentence.

Server stores the candidate proposal sentence in a temporary buffer or in an intermediate table for content checking.

### Step 15:

Server performs content checking on the candidate proposal sentence.

Server uses, as input, the candidate proposal sentence and the original context object.

Server evaluates whether the candidate proposal sentence satisfies constraints, including presence of a recommended acquisition time, presence of a recommended platform, absence of prohibited terms, and alignment with numerical values such as price and discount percentage.

Server performs this evaluation by applying pattern-matching rules, numeric consistency checks, and content filters.

Server outputs either an approved proposal sentence or a decision that the candidate proposal sentence is invalid.

If the candidate is invalid, server may modify the prompt sentence and repeat the interaction with the generative AI model until a valid proposal sentence is obtained.

Server writes, as final output of this step, an approved proposal sentence to a recommendation-log table, linked to the corresponding prompt sentence and context.

### Step 16:

Server prepares a notification message for the terminal.

Server uses, as input, the approved proposal sentence and associated metadata such as item identifier and platform link.

Server encapsulates the proposal sentence and link into a communication-application-compatible message format.

Server transmits, as output, this message to the terminal via the communication application's messaging protocol.

### Step 17:

Terminal receives the message containing the proposal sentence from the server.

Terminal uses, as input, the proposal message and renders the textual content as a notification or chat message on a display.

User views the displayed proposal sentence and may choose to interact with it.

User taps a button or link embedded in the message to proceed to the recommended transaction platform, or otherwise responds via an additional message.

Terminal sends, as output to the server, a response event including at least the user action type (for example, click, purchase confirmation, ignore) and identifiers for the related proposal and prompt.

### Step 18:

Server logs user response results and updates models and rules.

Server uses, as input, response events received from the terminal and the existing records in the prompt-log and recommendation-log tables.

Server associates each response event with the corresponding prompt sentence, proposal sentence, and context object.

Server performs data aggregation and analysis on these linked records, computing metrics such as click-through rate and purchase conversion rate for each prompt pattern and timing condition.

Server updates, as output, internal parameters of the timing-prediction model and the prompt-generation rules.

Server may adjust model weights using the new data as additional training examples, and may change selection rules among prompt patterns based on observed performance, thereby refining the generative AI conditioning and improving prediction accuracy and notification efficiency for subsequent executions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

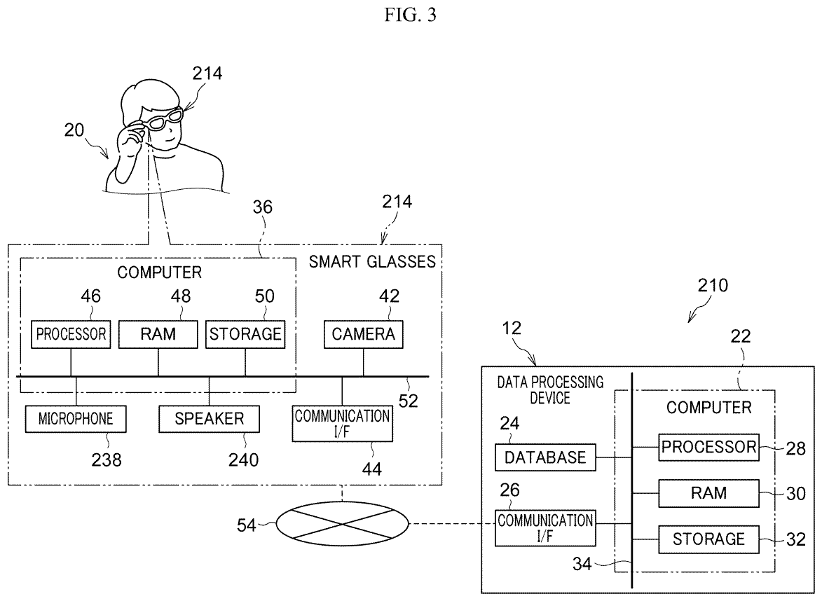

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

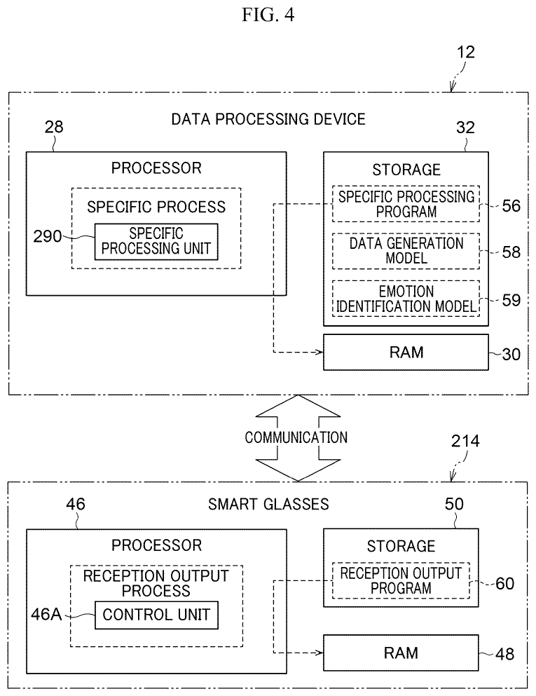

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

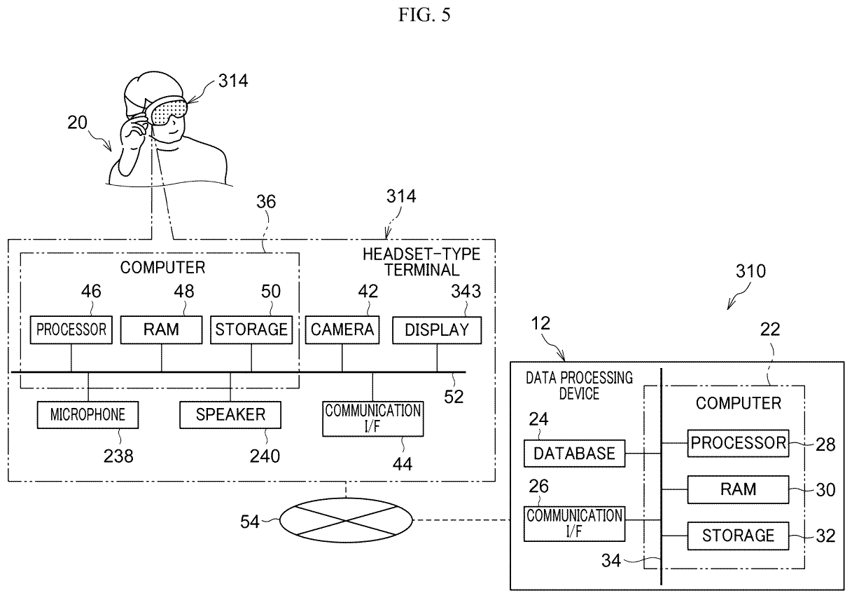

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

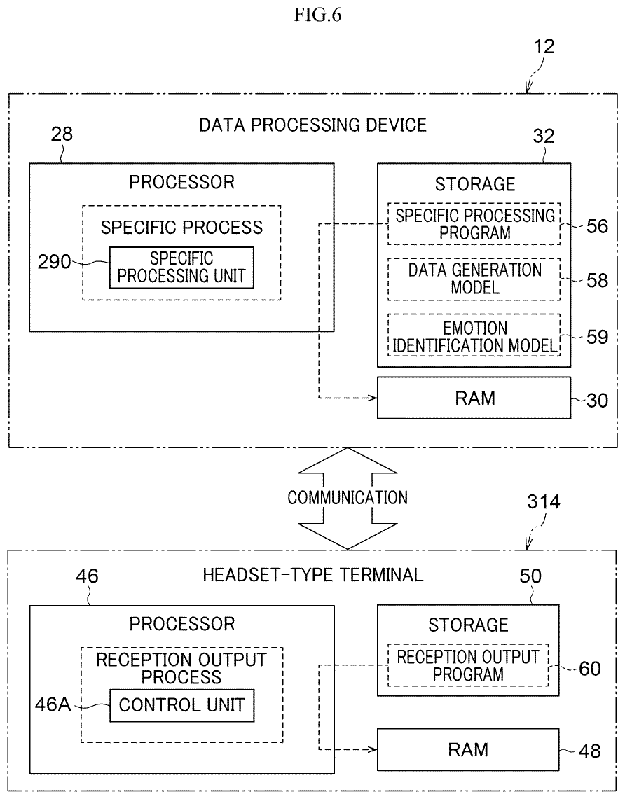

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

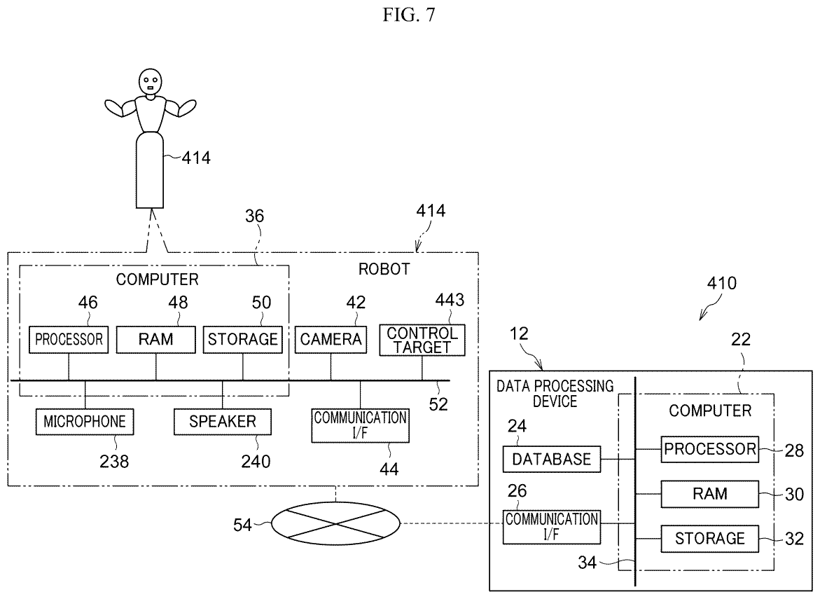

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

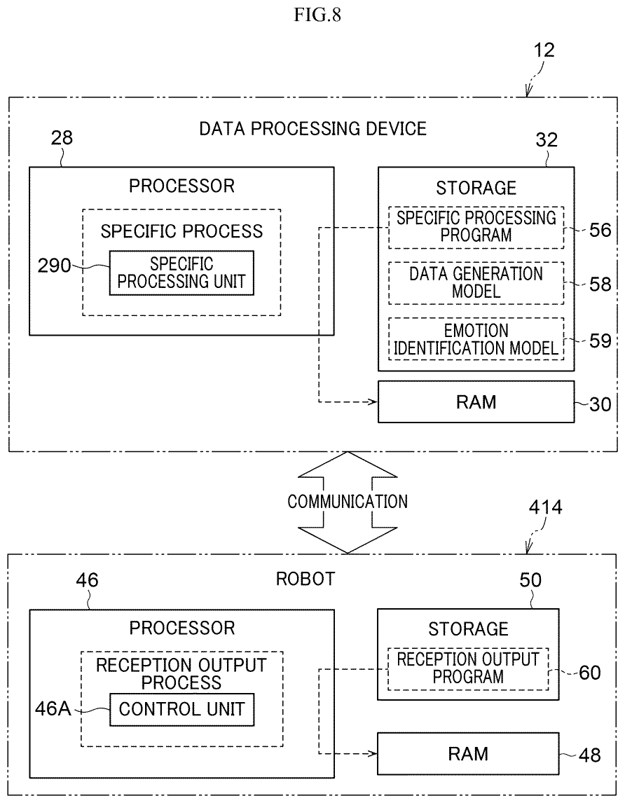

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

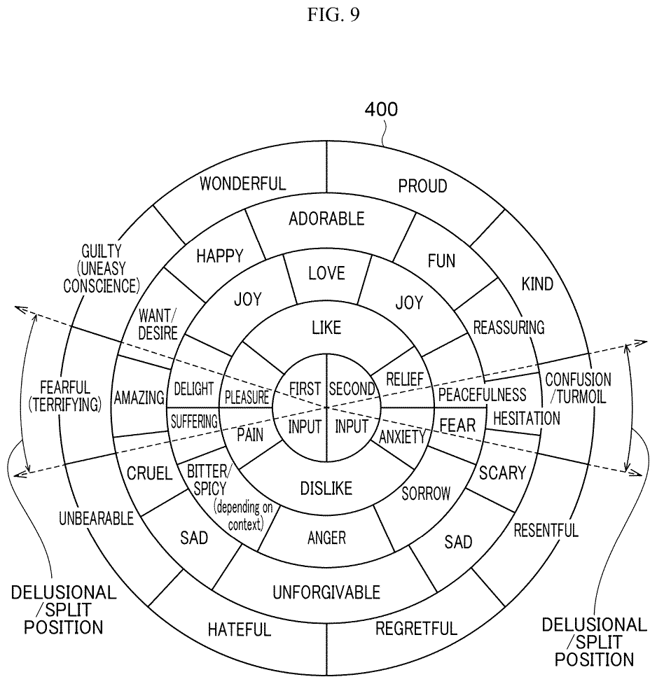

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

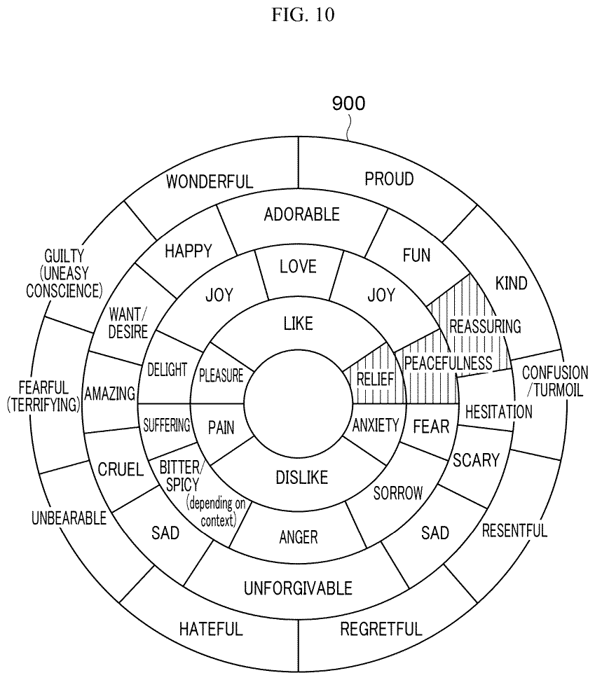

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
acquire authentication information of a user in order to associate identification information between a communication function and a transaction function, store the authentication information in the storage device, and perform connection control using an authentication scheme based on the authentication information,
receive, via a user interface of a terminal device, input information regarding target data that the user desires to periodically obtain and setting information regarding an acquisition interval, and register the input information and the setting information in the storage device as time-series management data,
acquire history data accumulated in the storage device, calculate an acquisition frequency and an acquisition tendency of the target data by using at least one of a time-series analysis method and a statistical analysis method, and generate acquisition schedule information including a next scheduled acquisition time,
receive evaluation index data dynamically obtained from a plurality of transaction functions via a communication path, extract price information and availability information included in the evaluation index data, and derive optimal acquisition candidate information by a comparison processing algorithm,
construct a prompt sentence in a natural language for input to a generative information processing model on the basis of the acquisition schedule information and the optimal acquisition candidate information, and dynamically generate the prompt sentence by embedding, into the prompt sentence, at least a name of the target data, the scheduled acquisition time, and a price condition and a discount condition based on the evaluation index data,
transmit, to the generative information processing model, input data including the prompt sentence, receive proposal text data generated by the generative information processing model, and format a length, an expression style, and an output format of the proposal text data according to predetermined conditions,
generate notification message data by combining the formatted proposal text data with identifiers, date and time information, and destination information included in the acquisition schedule information and the optimal acquisition candidate information, transmit the notification message data to the terminal device via a notification interface of the communication function, and record transmission history of the notification message data in the storage device,
transmit, to the transaction function, a transaction request according to an operation instruction from the terminal device by using the destination information included in the notification message data, acquire response data to the transaction request, register the response data as additional history data in a history database of the storage device, and update the acquisition schedule information based on the response data, and
execute, at predetermined intervals, an evaluation process for updating a configuration condition of the prompt sentence or a generation condition of the proposal text data on the basis of the history data and the transmission history, and reflect a result of the evaluation process in subsequent prompt sentence generation processing and notification message generation processing.

### (Supplementary 2)

The system according to supplementary 1,
wherein the processor is configured to
learn, by using a machine learning method, an acquisition pattern for each user based on the history data and the acquisition schedule information accumulated in the storage device, and add attribute information or preference information indicating the acquisition pattern into the prompt sentence to be input to the generative information processing model so that the proposal text data generated by the generative information processing model has a writing style, a length, and emphasis points that are different for each user.

### (Supplementary 3)

The system according to supplementary 1,
wherein the processor is configured to
generate, when a price fluctuation or an availability fluctuation exceeding a threshold is detected based on a change amount of the evaluation index data acquired from the plurality of transaction functions and the history data, an additional prompt sentence independently of the acquisition schedule information, cause the generative information processing model to generate proposal text data corresponding to the price fluctuation or the availability fluctuation based on the additional prompt sentence, and transmit the proposal text data to the terminal device via the communication function.

### Application Example 1

### (Supplementary 1)

A system comprising a processor,
wherein the processor is configured to
receive user authentication information via a communication application executed on an information processing apparatus, acquire user identification information through the communication application, acquire transaction identification information through a commerce application executed on an information processing apparatus, associate the user identification information with the transaction identification information, and register the associated identification information in a storage device,
cause a user interface including a display device and an input device to receive input of identification information of goods or services repeatedly acquired by a user and information regarding an acquisition interval for the goods or services, and store the input information in the storage device as periodic acquisition target information,
acquire past transaction record data corresponding to the user via the commerce application, calculate, for each good or service included in the transaction record data, a representative value of an acquisition interval and a variation index by applying a statistical processing algorithm to acquisition time information and acquisition quantity information included in the transaction record data, and store calculation results as statistical information in the storage device,
calculate, on the basis of the statistical information and the periodic acquisition target information, a next scheduled acquisition time for each good or service, generate a notification schedule time by applying a predetermined lead time to the next scheduled acquisition time, and register schedule information including the notification schedule time in the storage device,
acquire price-related data for each good or service included in the periodic acquisition target information from a plurality of commerce applications, calculate, for each piece of the price-related data, a total payment amount based on sales price information and delivery condition information included in the price-related data, select, by using a comparison processing algorithm, at least one candidate that satisfies a predetermined condition regarding the total payment amount, and store the selected candidate as an optimal acquisition option in the storage device,
generate structured data including proposal content to be presented to the user, the proposal content being based on the next scheduled acquisition time and the optimal acquisition option, generate a prompt sentence for inputting the structured data to a generative information processing model configured to generate explanatory text, and transmit the prompt sentence to the generative information processing model,
receive, from the generative information processing model, a proposal text expressed in a natural language, generate a notification message by adding reference information of a transaction screen of the commerce application to the proposal text, and transmit the notification message to a user terminal via the communication application, update the statistical information and the schedule information on the basis of new transaction record data received from the commerce application after transmission of the notification message, and recalculate subsequent next scheduled acquisition times and notification schedule times, and
acquire, via the communication application, a configuration change request message expressed in a natural language and transmitted by the user, generate and transmit to the generative information processing model a prompt sentence for obtaining structured data representing an intent, a target good or service, and a change of the acquisition interval from the configuration change request message, receive an analysis result from the generative information processing model, and update the periodic acquisition target information and the schedule information on the basis of the analysis result.

### (Supplementary 2)

The system according to supplementary 1,
wherein the processor is configured to
apply a machine learning algorithm to the transaction record data to learn, for each good or service, an acquisition pattern including seasonality, calculate a correction value for the next scheduled acquisition time on the basis of a prediction model different from the statistical processing algorithm, and dynamically update at least one of the next scheduled acquisition time and the notification schedule time on the basis of the correction value.

### (Supplementary 3)

The system according to supplementary 1,
wherein the processor is configured to
calculate an evaluation index based on at least the transaction record data, the statistical information, the price-related data, and explanatory information included in the proposal text received from the generative information processing model, the evaluation index reflecting at least one of an expenditure history of the user and an acquisition frequency of each good or service, assign priorities to a plurality of acquisition candidates on the basis of the evaluation index, and select a presentation target to be included in the notification message.

### Example 2

### (Supplementary 1)

A system comprising a processor,
wherein the processor is configured to
acquire identification information and authentication information of a user associated with a communication function and a transaction function, perform an authentication process based on the authentication information, associate identification information corresponding to the communication function and the transaction function, and store the associated identification information in a storage device,
receive, via a presentation function, input information including attribute information of an acquisition target repeatedly acquired by the user and information regarding an acquisition cycle of the acquisition target, normalize the input information, and register the normalized input information as target management information in the storage device,
collect past transaction information from an external provision function, perform preprocessing including missing-value completion processing and conversion processing to a unified time axis on the collected transaction information, and store the preprocessed transaction information as learning data in the storage device,
execute a learning process using the learning data as input data to generate a machine learning model for performing time-series analysis, and calculate prediction information by using the machine learning model to predict, for each acquisition target, a time interval until a next acquisition,
acquire price information and associated condition information from a plurality of transaction provision functions, calculate an effective price index for each candidate based on the price information and the associated condition information, and determine, based on the prediction information and user setting conditions, recommendation information including a recommended acquisition time and recommended acquisition conditions for each acquisition target,
generate internal data in which the prediction information and the recommendation information are structured, and dynamically create a prompt sentence to be input to a generative information processing model by embedding the internal data into an instruction sentence for explanation,
input the prompt sentence and the internal data into the generative information processing model, execute a generation result acquisition process to cause the generative information processing model to generate an explanatory sentence or a proposal sentence to be presented to the user, and transmit the generated explanatory sentence or proposal sentence to a user terminal via the communication function, and
generate relearning data for updating the learning data and the machine learning model based on response information received from the user terminal, and execute a relearning process using the relearning data to improve accuracy of the prediction information.

### (Supplementary 2)

The system according to supplementary 1,
wherein the processor is configured to, in the learning process of the machine learning model, divide transaction history information into time-series data, perform feature extraction processing and data splitting processing on the time-series data, train the machine learning model to output the time interval until the next acquisition by using a recursive model or a sequence conversion model, and generate the prediction information on a per-user and per-acquisition-target basis by using the trained model.

### (Supplementary 3)

The system according to supplementary 1,
wherein the processor is configured to, in creating the prompt sentence to be input to the generative information processing model, generate structured data summarizing the prediction information and the recommendation information, assemble an instruction sentence for explanation including the structured data and instructions defining notification targets, explanation detail level, writing style, and length constraints, and input the instruction sentence as the prompt sentence to the generative information processing model.

### Application Example 2

### (Supplementary 1)

A system comprising a processor,
wherein the processor is configured to
acquire user identification information of a communication application and a commercial transaction platform in order to associate identification information between the communication application and the commercial transaction platform, and to store the acquired user identification information in a storage device,
to cause a user interface to receive, from a user, attribute information and acquisition interval information regarding an acquisition target that the user repetitively acquires, and to register the received information in the storage device,
to obtain past acquisition history information stored in the storage device, to perform statistical computation processing and machine learning processing on the past acquisition history information so as to calculate feature information indicating acquisition intervals and acquisition tendencies, and to generate acquisition frequency information for each acquisition target,
to obtain transaction price information regarding the acquisition target from a plurality of commercial transaction platforms in real time, and to normalize the obtained transaction price information and store the normalized transaction price information as price list information in the storage device,
to perform numerical computation processing on the price list information so as to specify a minimum price and transaction source information that provides the minimum price, and to calculate discount rate information by comparing the minimum price with a reference price based on past price history,
to calculate a next scheduled acquisition time by performing prediction calculation based on the acquisition frequency information and the acquisition history information using a current time as an input, and to calculate a recommended acquisition time by taking into account the discount rate information and the minimum price,
to perform natural language processing on expression information acquired from the user via the communication application so as to calculate emotion type information and emotion strength information indicating an emotion state of the user, and to store the emotion type information and the emotion strength information in the storage device,
to construct context information including the recommended acquisition time, the minimum price, the transaction source information, the acquisition frequency information, and the emotion type information, and to generate, in a natural language, a prompt sentence for generation of a proposal sentence based on the context information,
to transmit the prompt sentence as an input to a generative artificial intelligence model, to receive a candidate proposal sentence output from the generative artificial intelligence model, and to perform content checking processing on the candidate proposal sentence so as to determine a proposal sentence indicating the recommended acquisition time and a recommended transaction source,
to transmit the determined proposal sentence to a user terminal via the communication application, and to cause the user terminal to display the proposal sentence as a notification, to store the prompt sentence, the proposal sentence, and a response result of the user to the proposal sentence in association with each other in the storage device, and
to update a generation rule for the prompt sentence and learning parameters of a machine learning model used in the prediction calculation based on a history stored in the storage device so as to improve subsequent proposal sentence generation processing and acquisition time prediction processing.

### (Supplementary 2)

The system according to supplementary 1,
wherein the processor is configured to
execute a machine learning algorithm using the past acquisition history information as an input so as to learn acquisition patterns, and to probabilistically predict the next scheduled acquisition time for each acquisition target for each user.

### (Supplementary 3)

The system according to supplementary 1,
wherein the processor is configured to
generate the prompt sentence using the context information including the past acquisition history information, current market price information, and emotion state information of the user, and to present, based on the proposal sentence obtained from the generative artificial intelligence model, an acquisition recommendation option in which an acquisition time and transaction conditions are optimized simultaneously.

What is claimed is:

1. A system comprising:
circuitry configured to:
acquire, via a communication interface coupled to a packet-switched network, user identification data from a terminal device, associate the user identification data with account identification data of one or more external service platforms, and store the associated identification data in an information storage device;
acquire target item registration data from the terminal device, the target item registration data comprising attribute data and periodicity data for one or more monitored items, and store the target item registration data in the information storage device;
collect historical transaction records from the one or more external service platforms via the communication interface, execute preprocessing on the historical transaction records comprising missing-value completion and timestamp normalization to a unified time axis, and store the preprocessed records as learning data in the information storage device;
train a time-series machine learning model using the learning data as input, and generate prediction data by causing the time-series machine learning model to output, for each monitored item, a predicted time interval until a next occurrence;
acquire current condition data from a plurality of external information providing apparatuses via the communication interface, compute an effective value index for each candidate by applying a comparison algorithm to the current condition data, and determine recommendation data comprising a recommended timing and recommended condition parameters based on the prediction data and stored preference parameters;
construct a prompt data structure by embedding the prediction data and the recommendation data into an instruction sequence specifying notification target parameters, detail level, and length constraints, and transmit the prompt data structure to a generative neural network model comprising a transformer-based architecture to acquire generated notification text data; and
transmit the generated notification text data to the terminal device via the communication interface.

2. The system according to claim 1, wherein the time-series machine learning model comprises a recurrent neural network configured to process sequential input vectors derived from the learning data, and the prediction data comprises a probability distribution over future time intervals for each monitored item.

3. The system according to claim 2, wherein the circuitry is further configured to retrain the time-series machine learning model periodically by incorporating newly collected historical transaction records into the learning data and executing an incremental training operation.

4. The system according to claim 1, wherein the preprocessing further comprises converting heterogeneous data formats from the one or more external service platforms into a unified record format, deduplicating records based on identifier matching, and computing derived feature values comprising inter-event interval durations and cumulative quantity values.

5. The system according to claim 4, wherein the circuitry is further configured to compute statistical summary values from the preprocessed records comprising mean interval, variance, trend direction, and seasonal pattern indicators for each monitored item.

6. The system according to claim 1, wherein the comparison algorithm comprises normalizing the current condition data from the plurality of external information providing apparatuses to a common scale, computing a weighted score for each candidate based on a plurality of condition attributes, and ranking the candidates by the weighted score.

7. The system according to claim 6, wherein the condition attributes comprise at least a primary value parameter, a discount parameter, a delivery time parameter, and a rating parameter, and the weights are derived from user preference data stored in the information storage device.

8. The system according to claim 1, wherein the circuitry is further configured to acquire affective state data from the terminal device, input the affective state data into an emotion identification model to compute an emotion category and an emotion intensity value, and adjust at least one of the detail level or the length constraints in the prompt data structure based on the emotion category.

9. The system according to claim 8, wherein the affective state data comprises at least one of facial image data, voice spectrogram data, or text sentiment data, and the emotion identification model comprises a neural network classifier that outputs the emotion category from a predefined set of emotion labels.

10. The system according to claim 8, wherein the circuitry adjusts the prompt data structure by specifying a concise notification style when the emotion category indicates a busy or stressed state, and specifying a detailed explanation style when the emotion category indicates an engaged or relaxed state.

11. The system according to claim 1, wherein the circuitry is further configured to acquire response data from the terminal device indicating user acceptance or rejection of the recommendation data, and generate relearning data from the response data for updating the time-series machine learning model.

12. The system according to claim 11, wherein the circuitry is further configured to update the stored preference parameters based on the response data by increasing weight values for condition attributes associated with accepted recommendations and decreasing weight values for condition attributes associated with rejected recommendations.

13. The system according to claim 1, wherein the circuitry is further configured to monitor the current condition data on a periodic schedule, detect a condition event when the effective value index for a monitored item satisfies a threshold condition, and trigger generation of the notification text data in response to the condition event.

14. The system according to claim 13, wherein the circuitry is further configured to compute an urgency score for the condition event based on a proximity of the predicted time interval to a current timestamp and a magnitude of the effective value index, and prioritize notification generation for condition events having higher urgency scores.

15. The system according to claim 1, wherein the circuitry is further configured to generate a summary report comprising aggregated historical transaction data, prediction accuracy metrics, and recommendation acceptance rates for transmission to the terminal device.

16. The system according to claim 1, wherein the circuitry is further configured to associate the user identification data with a messaging service account via an authentication protocol, and transmit the generated notification text data to the terminal device through the messaging service account.

17. The system according to claim 1, wherein the monitored items comprise household consumable products, the historical transaction records comprise purchase records from electronic commerce platforms, the current condition data comprises product price and availability data, and the generated notification text data comprises a purchase recommendation message.

18. A system comprising:
circuitry configured to:
acquire user identification data and target item registration data from a terminal device via a communication interface, and store associated data in an information storage device;
collect historical transaction records from external service platforms, preprocess the records, and train a time-series machine learning model to generate prediction data for each monitored item;
acquire current condition data from a plurality of external information providing apparatuses, compute an effective value index, and determine recommendation data based on the prediction data;
construct a prompt data structure comprising the prediction data and the recommendation data, transmit the prompt data structure to a generative neural network model, and acquire generated notification text data; and
transmit the generated notification text data to the terminal device.

19. The system according to claim 18, wherein the circuitry is further configured to acquire affective state data from the terminal device, compute an emotion category using an emotion identification model, and adjust the prompt data structure based on the emotion category.

20. A method performed by circuitry via a communication interface coupled to a packet-switched network, the method comprising:
acquiring user identification data from a terminal device, associating the user identification data with account identification data of one or more external service platforms, and storing the associated identification data in an information storage device;
acquiring target item registration data comprising attribute data and periodicity data for monitored items;
collecting historical transaction records from the external service platforms, executing preprocessing comprising missing-value completion and timestamp normalization, and training a time-series machine learning model using the preprocessed records to generate prediction data;
acquiring current condition data from a plurality of external information providing apparatuses, computing an effective value index by applying a comparison algorithm, and determining recommendation data based on the prediction data;
constructing a prompt data structure by embedding the prediction data and the recommendation data into an instruction sequence, and transmitting the prompt data structure to a generative neural network model comprising a transformer-based architecture to acquire generated notification text data; and
transmitting the generated notification text data to the terminal device.
